(19) United States
(12) Patent Application Publication
(10) Pub. No.: US 2015/0094139 A1
(43) Pub. Date: Apr. 2, 2015

(54) SYSTEMS AND METHODS FOR SOCIAL GAMING

(71) Applicant: GimiGimi Inc., Richmond Hill (CA)

(72) Inventor: Pedram KARGAR, Richmond Hill (CA)

(21) Appl. No.: 14/483,660

(22) Filed: Sep. 11, 2014

Related U.S. Application Data
(60) Provisional application No. 61/883,723, filed on Sep. 27, 2013.

(51) Int. Cl. A63F 13/79; A63F 13/35

(52) U.S. Cl. CPC A63F 13/79; A63F 13/35
USPC 463/29

(57) ABSTRACT

Various embodiments are described herein for methods and systems for operating a gaming system. The gaming system is configured to interface with a client system. In one example embodiment, the gaming system includes a processor configured to establish a database of activity records where the database has at least one activity record associated with a social gaming activity. Each activity record has an eligibility field identifying an eligibility requirement associated with the social gaming activity. The processor is configured to receive, from the client system, a membership request, which configures the processor to generate a client profile corresponding to the client system. The gaming system determines if the client system is eligible to participate in a social gaming activity selected by the client system based on the eligibility field of the activity record corresponding to the selected social gaming activity.

### TECHNICAL FIELD

The described embodiments relate to methods and systems for providing social gaming activities to users, and in particular, to methods and systems for controlling eligibility, progress and rewards of users participating in social gaming activities.

### BACKGROUND

The popularity of online games continues to increase. Online games include games played over a computer network, such as the internet. Providers of online gaming services are continually searching for ways to monetize the popularity of online games. Integrating gameplay with social interaction may provide opportunities to online gaming service providers to monetize the popularity of online games.

### SUMMARY

In a broad aspect, at least one embodiment described herein provides a method of operating a gaming system, the gaming system being configured to interface with a client system. The method comprises operating at least one processor to establish a database of activity records, the database having at least one activity record associated with a social gaming activity, each activity record having an eligibility field identifying an eligibility requirement associated with the social gaming activity; storing the database in a memory; receiving, from the client system, a membership request, the membership request configuring the at least one processor to generate a client profile corresponding to the client system in the memory; providing, to the client system, data identifying the activity records; receiving, from the client system, a selection request identifying a first selected social gaming activity; determining if the client system is eligible to participate in the first selected social gaming activity based on the eligibility field of the activity record corresponding to the first selected social gaming activity; and enrolling the client system in the social gaming activity when eligibility is established.

In some embodiments, the method for operating a gaming system further comprises receiving a referral request from the client system, the referral request configuring the at least one processor to provide a connection to the gaming system to a non-client system identified in the referral request.

In some embodiments, the method for operating a gaming system further comprises receiving a friend request from the client system, the friend request identifying another client system having a corresponding client profile generated in the memory; and configuring the at least one processor to connect the client system to the client system identified in the friend request.

In some embodiments, the method for operating a gaming system further comprises operating the at least one processor to establish a database of user records, each user record corresponding to one client profile from a plurality of client profiles generated in the memory.

In some embodiments, each user record comprises a friend count field, the friend count field identifying a total number of friends associated with the user record.

In some embodiments, the friend count field is incremented when the at least one processor is configured to connect one client system to another client system in response to a friend request.

In some embodiments, the method for operating a gaming system further comprises operating the at least one processor to establish a database of advertisement records, each advertisement record corresponding to an advertisement.

In some embodiments, the advertisement is a non-interactive advertisement.

In some embodiments, the advertisement is an interactive advertisement.

In some embodiments, the method for operating a gaming system further comprises recording an engagement level of a client system towards the interactive advertisement.

In some embodiments, the method for operating a gaming system further comprises providing virtual currency to the client system based on the recorded engagement level.

In some embodiments, the method for operating a gaming system further comprises receiving a credit from a sponsor based on the recorded engagement level.

In some embodiments, the interactive advertisement comprises a non-interactive portion followed by an interactive portion.

In some embodiments, the non-interactive portion comprises promotional content and the interactive portion comprises a quiz based on the non-interactive portion.

In some embodiments, the interactive advertisement comprises a non-interactive portion integrated with an interactive portion.

In some embodiments, the non-interactive portion comprises promotional content and the interactive portion integrated with the non-interactive portion comprises a game integrated within the promotional content.

In some embodiments, the participation of the client system in the game integrated with the promotional content is monitored to gauge engagement level of the client system.

In some embodiments, the method for operating a gaming system further comprises providing an advertisement to the client system prior to enrolling the client system in the social gaming activity.

In some embodiments, the method for operating a gaming system further comprises providing an advertisement to the client system during the social gaming activity.

In some embodiments, the method for operating a gaming system further comprises providing an advertisement to the client system after the social gaming activity.

In some embodiments, the method for operating a gaming system further comprises recording the number of advertisements viewed by the client system.

In some embodiments, the method for operating a gaming system further comprises providing a credit to the client system based on the number of advertisements viewed.

In some embodiments, the credit comprises virtual currency.

In some embodiments, the credit comprises real currency.

In some embodiments, the credit comprises eligibility to participate in the social gaming activity.

In some embodiments, the method for operating a gaming system further comprises updating the client profile to increment the ad count field, the ad count field reflecting the number of advertisements viewed by the client system corresponding to the client profile.

In at least one embodiment, operating the at least one processor to establish a database of activity records comprises operating the at least one processor to establish a database of game records, each game record corresponding to a social game.

In some embodiments, the social game is a single-player game.

In some embodiments, the single-player game comprises a multi-player mode.

In some embodiments, the social game is a multi-player game.

In some embodiments, the multi-player game comprises a single-player mode.

In some embodiments, the social game comprises at least one single-player portion and at least one multi-player portion.

In some embodiments, the game record further comprises game information selected from the group consisting of: game title, game type, game sponsor, game award and game winning requirement.

In some embodiments, the eligibility field contained in the activity record comprises an eligibility requirement corresponding to the social game.

In some embodiments, the eligibility requirement comprises a minimum friend requirement indicating a minimum number of friends required by the client system for participating in the social game.

In some embodiments, the eligibility requirement comprises an entry fee requirement indicating a fee required to be paid by the client system for participating in the social game.

In some embodiments, the eligibility requirement comprises an advancing fee requirement indicating a fee required to be paid by the client system for advancing in the social game.

In some embodiments, the social game is a game provided on a sponsor page, and the eligibility requirement requires the client system to like the sponsor page.

In some embodiments, the winning requirement comprises achieving the highest score in the social game.

In some embodiments, the winning requirement comprises a first to finish requirement.

In some embodiments, the game award comprises virtual currency.

In some embodiments, the game award comprises real currency.

In some embodiments, the game award comprises coupons for products.

In some embodiments, the game award comprises real-value products.

In at least one embodiment, operating the at least one processor to establish a database of activity records comprises operating the at least one processor to establish a database of tournament records, each tournament record corresponding to a tournament.

In some embodiments, the tournament comprises a competition based on a social game.

In some embodiments, the tournament comprises a competition based on an advertisement.

In some embodiments, the tournament record further comprises tournament information selected from the group consisting of: tournament title, tournament type, tournament sponsor, tournament duration, tournament entry fee, tournament start condition, and tournament award.

In some embodiments, the tournament start condition indicates a number of participants enrolled in the tournament before the tournament begins. In some embodiments, the duration of the tournament indicates the span of time over which the tournament is active.

In some embodiments, the gaming system provides some tournaments with a frequency of one day, some tournaments with a frequency of one week, some tournaments with a frequency of one month, some tournaments with a frequency of one year, and/or a combination of some of the above-mentioned tournaments.

In some embodiments, the eligibility field contained in the activity record comprises an eligibility requirement corresponding to the tournament.

In some embodiments, the eligibility requirement comprises a minimum friend requirement indicating a minimum number of friends required by the client system for participating in the tournament.

In at least on embodiment, operating the at least one processor to establish a database of activity records comprises operating the at least one processor to establish a database of draw records, each draw record corresponding to a draw.

In some embodiments, the draw record further comprises draw information selected from the group consisting of: draw title, draw type, draw sponsor, draw duration, draw start time, and draw award.

In some embodiments, the draw duration indicates the frequency of drawing winners corresponding to the draw.

The gaming system may carry out one or more draws, and each draw may be carried out at one or more different frequencies. In some embodiments, the draw frequency is one day. In some other embodiments, the draw frequency is one week.

In some embodiments, the draw frequency is one month. In some other embodiments, the draw frequency is one year. In some further embodiments, a draw may be carried out a combination of daily, weekly, monthly or yearly frequencies.

In some embodiments, the eligibility field contained in the activity record comprises an eligibility requirement corresponding to the draw.

In some embodiments, the eligibility requirement comprises a minimum friend requirement indicating a minimum number of friends required by the client system for participating in the draw.

In some embodiments, the eligibility requirement comprises an online status requirement indicating whether the client system participating in the draw is connected to the gaming system.

In some embodiments, the method of operating a gaming system further comprises operating the at least one processor to establish a database of sponsor records, each sponsor record corresponding to a sponsor.

In some embodiments, the sponsor record records the advertisements funded by the sponsor.

In some embodiments, the sponsor record records the social gaming activities funded by the sponsor.

In another aspect, in at least one embodiment described herein, there is provided a system for providing a social gaming activity to a client system, the gaming system being configured to interface with the client system. The system comprises at least one processor configured to establish a database of activity records, the database having at least one activity record associated with a social gaming activity, each activity record having an eligibility field identifying an eligibility requirement associated with the social gaming activity; store the database in a memory; receive, from the client system, a membership request, the membership request configuring the at least one processor to generate a client profile corresponding to the client system in the memory; provide, to the client system, data identifying the activity records; receive, from the client system, a selection request identifying a first selected social gaming activity; determine if the client system is eligible to participate in the first selected social gaming activity based on the eligibility field of the activity record corresponding to the first selected social gaming activity; and enroll the client system in the social gaming activity when eligibility is established.

In another embodiment the at least one processor is configured to perform the methods as described above.

In another aspect, in at least one embodiment described herein, there is provided a computer-readable medium storing computer-executable instructions. The instructions cause a processor to perform a method of operating a gaming system, the gaming system being configured to interface with a client system, the method comprising: operating at least one processor to establish a database of activity records, the database having at least one activity record associated with a social gaming activity, each activity record having an eligibility field identifying an eligibility requirement associated with the social gaming activity; storing the database in a memory; receiving, from the client system, a membership request, the membership request configuring the at least one processor to generate a client profile corresponding to the client system in the memory; providing, to the client system, data identifying the activity records; receiving, from the client system, a selection request identifying a first selected social gaming activity; determining if the client system is eligible to participate in the first selected social gaming activity based on the eligibility field of the activity record corresponding to the first selected social gaming activity; and enrolling the client system in the social gaming activity when eligibility is established.

In some embodiments, the instructions cause the processor to perform the methods as described above.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

Several embodiments of the present invention will now be described in detail with reference to the drawings, in which:

FIG. 1 is a block diagram of components interacting with a gaming system in accordance with an example embodiment;

FIG. 2 is a block diagram of a gaming system in accordance with an example embodiment;

FIG. 3 is a game database in accordance with an example embodiment;

FIG. 4 is a tournament database in accordance with an example embodiment;

FIG. 5 is a process flow diagram for an example method of providing an advertisement to a user;

FIG. 6 is a process flow diagram for another example method of providing an advertisement to a user;

FIG. 7 is a process flow diagram for another example method of providing an advertisement to a user;

FIG. 8 is a process flow diagram for an example method of providing a social gaming activity to a user;

FIG. 9 is a process flow diagram for another example method of providing a social gaming activity to a user;

FIG. 10 is a process flow diagram for another example method of providing a social gaming activity to a user;

FIG. 11 is a screenshot of a display interface in accordance with an example embodiment;

FIG. 12 is a screenshot of a display interface in accordance with another example embodiment;

FIG. 13 is a screenshot of a display interface in accordance with another example embodiment;

FIG. 14 is a screenshot of a display interface in accordance with another example embodiment;

FIG. 15 is a screenshot of a browser in accordance with another example embodiment;

FIG. 16 is a draw database in accordance with an example embodiment;

FIG. 17 is a process flow diagram for an example method of providing a social gaming activity to a user;

FIG. 18 is a process flow diagram for another example method of providing a social gaming activity to a user;

FIG. 19 is a process flow diagram for another example method of providing a social gaming activity to a user;

FIG. 20 is a screenshot of a display interface in accordance with an example embodiment;

FIG. 21 is an advertisement database a tournament database in accordance with an example embodiment;

FIG. 22 is a screenshot of a display interface in accordance with an example embodiment;

FIG. 23 is a screenshot of a display interface in accordance with another example embodiment;

FIG. 24 is a screenshot of a display interface in accordance with another example embodiment;

FIG. 25 is a sponsor database in accordance with an example embodiment;

FIG. 26 is a screenshot of a display interface in accordance with an example embodiment;

FIG. 27 is a user database in accordance with an example embodiment;

FIG. 28 is a screenshot of a display interface in accordance with an example embodiment;

FIG. 29 is a screenshot of a display interface in accordance with an example embodiment; and

FIGS. 30A, 30B and 30C are screenshots of a display interface in accordance with another example embodiment.

The drawings are provided for the purposes of illustrating various aspects and features of the example embodiments described herein. For simplicity and clarity of illustration, elements shown in the FIGS. have not necessarily been drawn to scale. Further, where considered appropriate, reference numerals may be repeated among the FIGS. to indicate corresponding or analogous elements.

### DETAILED DESCRIPTION

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, mobile telephone, smartphone or any other computing device capable of being configured to carry out the methods described herein.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a non-transitory computer readable storage medium (e.g. read-only memory, magnetic disk, optical disc). The storage medium so configured causes a computer to operate in a specific and predefined manner to perform the functions described herein.

While particular combinations of various functions and features are expressly described herein, other combinations of these features and functions are possible that are not limited by the particular examples disclosed herein, and these are expressly incorporated within the scope of the present invention.

As the term module is used in the description of the various embodiments, a module includes a functional block that is implemented in hardware or software, or both, that performs one or more functions such as the processing of an input signal to produce an output signal. As used herein, a module may contain sub-modules that themselves are modules.

The various embodiments described herein generally relate to methods and systems for providing social gaming activities. Social gaming activities include activities integrated with a social interaction component.

The social interaction component facilitates a user to communicate with other users of the social gaming activities. A user may communicate with other users by, for example, visiting user profiles, viewing status updates of other users, adding other users as friends, and the like.

The various embodiments described herein generally relate to systems and methods for controlling user eligibility to participate in social gaming activities, user progress within the social gaming activity and user rewards.

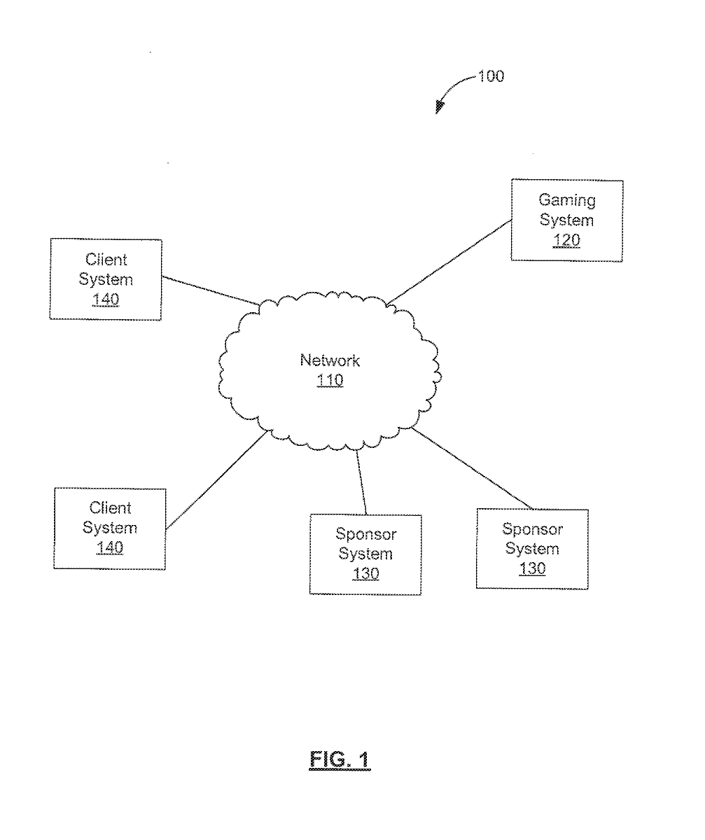

Reference is first made to FIG. 1, illustrating a block diagram of components interacting with a gaming system in accordance with an example embodiment. System 100 of FIG. 1 includes a gaming system 120, one or more sponsor systems 130, and a plurality of client systems 140. Each of the gaming system 120, one or more sponsor systems 130 and client systems 140 communicate among each other via network 110.

Network 110 may be any network or network components capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.), and others, including any combination of these.

Client system 140 may be any networked computing device, including a processor and memory, capable of communicating with a network. A computing device may be a personal computer, workstation, server, portable computer, mobile phone, laptop wirelessly coupled to an access point (e.g. a wireless router, a cellular communications tower, etc.), a wirelessly enabled personal data assistant (PDA) or smart phone, a terminal, a tablet computer, a game console over a wired or wireless connection, WAP phone, or a combination of these.

Client system 140 typically includes one or more input devices, such as a keyboard, mouse, camera, touch screen and a microphone etc., and also includes one or more output devices such as a display screen and a speaker etc. Client system 150 has a network interface for connecting to network 110 in order to communicate with other components within system 100.

In various embodiments, client system 140 comprises a client which may be an application, such as a computing application, application plug-in, a widget, mobile device application, Java™ application, or web browser executed by the client system 140 in order to send or transmit data.

Sponsor system 130 may be any networked computing device, including a processor and memory, capable of communicating with a network. Sponsor system 130 is a server system that provides promotional services for one or more products and/or services.

Sponsor system 130 may comprise one or more media servers for providing multimedia content, such as video and audio content. Sponsor system 130 may store a wide-variety of content, including games, advertisements, draws, tournaments, etc.

The sponsor system 130 is hosted by the operators of the gaming system 120. The sponsor system 130 may be maintained by third party advertisers or sponsors, who may be referred to herein as operators of sponsor system. In some cases, sponsor system 130 communicates with gaming system 120 to provide a sponsor page offering activities, such as tournaments, games, draws, advertisements etc. to the client system 140. In various cases, the sponsor system 130 and the gaming system 120 are distributed over a wide geographic area and connected via e.g. network 110, as illustrated in FIG. 1. In some other cases, the sponsor system 130 and the gaming system 120 are integrated into a signal system.

Gaming system 120 may be a server system that has one or more servers with computing processing abilities and memory such as database(s) or file system(s). Although one gaming system 120 is shown for clarity, there may be multiple gaming systems 120 distributed over a wide geographic area and connected via e.g. network 110. Gaming system 120 has a network interface for connecting to network 110 in order to communicate with other components and to serve web pages and other computing applications. The gaming system 120 is configured to receive and transmit data to one or more client systems 140 and sponsor systems 130.

Gaming system 120 is configured to provide a social gaming platform for providing access to social gaming activities to users of client system 140. A social gaming platform may be hosted on a server and may be connected to a series of individual client systems and sponsor systems through a network.

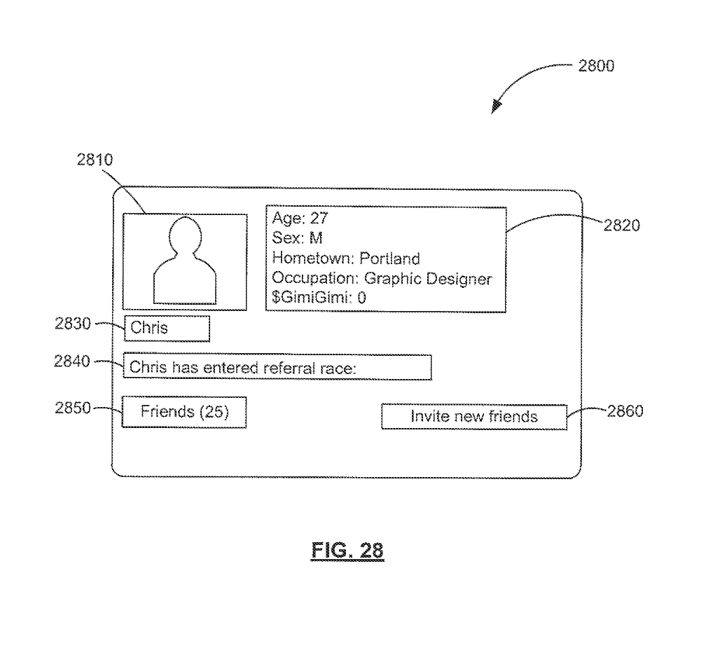

Gaming system 120 permits users to access the social gaming platform by creating an online profile in the gaming system 120. The user profile may be displayed to other users of the social gaming platform. FIG. 28 illustrates an example embodiment of a user profile.

In some cases, gaming system 120 provides access to social gaming activities on the platform in exchange for an entry fee. The entry fee may be real currency or virtual currency. The entry fee may also include certain tasks rather than real or virtual currency. For example, in some cases, gaming system 120 provides access to social gaming activities in exchange for viewing advertisements.

A user of client system 140 may create an online profile with the gaming system 120 by providing identification information, such as, for example, name, age, location, password, e-mail address, interests, etc. Gaming system 120 permits an account holding user to add other account holding users to his/her profile.

Gaming system 120 also permits the account holding users to introduce non-account holding users to the gaming system 120 and receive credit for it. Account holding users are those that have an existing user profile with the gaming system 120. Non-account holding users are those that do not have a user profile with the gaming system 120. Account holding users also include those that have temporarily disabled their accounts. However, account holding users do not include those who have permanently deleted their accounts. Only account holding users are eligible to participate in the social gaming activities provided by gaming system 120.

Gaming system 120 tracks the number of non-account holding users who have created an account with the gaming system 120 in response to the existing user's invitation. Gaming system 120 stores this information in the existing user's profile as referred friends.

Gaming system 120 provides opportunities to the participants of the social gaming activities to win rewards. In some cases, the rewards are in the form of virtual currency. In some other cases, the rewards are in the form of real currency. In some further cases, the rewards include products, services, and/or corresponding coupons having a real value. Various rewards offered by the gaming system include combinations of all of the above.

Social gaming activities may be categorized into social games, tournaments and draws. Social games are activities that allow a user to participate in a gameplay through a network. Examples of social games include, but are not limited to card games, board games, role-playing games, alternate reality games, skill testing games, first-person shooter games and other games that are accessed by a user using computer network (e.g. the internet), and provide opportunities for social interaction. Social games require active participation from one or more players to play and advance in the game.

A social game may be a single-player game, a multi-player game, or a combination of both. A single-player game is a game designed to be played and completed by a single player. A single-player game also includes a single-player portion of a multi-player game, where a portion or portions within a multi-player game are designed to be played and completed by a single player. This may include a qualification game to proceed to a next level within a multi-player game, where the qualification game is designed to be completed by a single-player only. A single-player game also includes a single-player mode of a social game where the game can be played and completed in both a single-player mode and a multi-player mode.

A multi-player game is a game designed to be played and completed by two or more players simultaneously. A multi-player game also includes multi-player portion or portions of any social game, where the social game is comprised of one or more single-player and multi-player portions. A multi-player game also includes a multi-player mode of a social game, where the social game is designed to be played and completed in both single-player and multi-player modes. Two or more players may play a multi-player game either co-operatively or in competition with each other.

Examples of single-player games include, but are not limited to, games where an input from only one player is expected throughout the gameplay, such as minesweeper, card games (e.g. solitaire), puzzle based games, skill-testing games (e.g. tetris, bubble shooting game), memory based games, reaction based games, and the like. Examples of single-player games may also include games where a user plays against computer controlled opponents, such as, but not limited to, card games (e.g. poker, blackjack and hearts), board games (e.g. chess, monopoly and backgammon), tower defense games, role-playing games, and the like.

Examples of multi-player games include, but are not limited to, card games such as poker, blackjack and hearts; board games, such as chess and monopoly; alternate reality games such as Farmville and clash of clans; co-operative and competitive shooting games; co-operative and competitive role-playing games; and the like where two or more players participate in a gameplay simultaneously in a co-operative or a competitive setting.

In some cases, social games have a finite or pre-defined duration. The duration of the games may be dynamically changeable. In some other cases, social games have no finite duration, and such games may be designed to end as soon as a prescribed goal is reached by a player.

In some cases, the social games are free to enter. In such cases, certain social games require the user to view one or more advertisements to enter. The user may also earn virtual currency based on the number of advertisements viewed. In some other cases, the tournaments require an entry fee for the user to enter. In such cases, the user can pay the entry fee using the virtual currency accumulated by the user. In some further cases, social games require the user to pay an advancing fee to advance in the game, or to speed up the game. For example, in some games, the user may be required to pay the advancing fee to advance to the next level in the game. In some other games, the user may be required to pay the advancing fee to expedite or speed up the gameplay, which may have the advantage of reaching one or more of the goals of the game faster.

Gaming system 120 also provides social gaming activities in the form of tournaments. A tournament is a challenge or a competition related to social activities, such as social games, draws or advertisements. A tournament may be described in terms of a set of conditions which, if met by a user, entitles the user to a reward.

A tournament may include a competition based on social games. For example, a tournament may be a competition to reward a user who reaches a certain level in a game the fastest, e.g. level 6 within 3 minutes of gameplay. There may be game based tournaments where the tournament conditions are not met even when the game ends. In such cases, the tournament extends over multiple instances of the social game on which it is based. In other words, a tournament may not end at the same time as the social game.

A tournament may also include a competition based on advertisements. Advertisements may be interactive or non-interactive, as discussed below. For example, a tournament may be a competition to reward those users who have watched a maximum number of advertisements within a defined duration of time.

Different tournaments may have different durations, different eligibility criteria and/or different rewards associated with them. For example, some tournaments may have a duration of one week, and some others may have a duration of one month.

In some cases, a user explicitly selects a tournament from a list of tournaments for participation. In some other cases, the gaming system automatically enters a user into a tournament.

Tournaments may have starting conditions associated with them. In some cases, each tournament has a minimum number of enrolled user limitation associated with it. In such cases, a tournament only starts when the prescribed minimum limit of enrolled users is met.

Tournament eligibility may be based on factors, such as, but not limited to, number of friends associated with a user profile, number of advertisements watched by the user, virtual currency associated with a user profile, and the like. Eligibility factors may be pre-determined and fixed in some cases, and dynamically changing in some other cases. Tournaments criteria may be determined by operators of gaming system 120.

In some cases, each tournament has a minimum number of friends requirement associated with it. In such cases, a user is allowed to participate in the tournament only if the user's friend count exceeds the minimum requirement.

In some further cases, the friend requirement for eligibility may be time dependent. In such cases, the user may not be eligible to participate in a tournament even if the minimum friend requirement is met if the user's friend count has not changed or evolved over a pre-determined time duration. For example, if a user is found to only have 100 friends for over six months, indicating that the user is not making an effort to add or refer more friends, the user may no longer be eligible to participate in a tournament even if that tournament only requires the user to have 100 friends for eligibility.

In most cases, the gaming system 120 offers a plurality of tournaments where the minimum friend requirement associated with each tournament is based on the reward offered in the tournament. In such cases, the friend requirement is greater in tournaments yielding greater rewards than the tournaments yielding lesser rewards, encouraging users to add and refer more friends.

Tournament rewards may be based on factors, such as, but not limited to, duration of the tournament, type and duration of the social activity corresponding to the tournament, number of participants in the tournament, and the like.

Gaming system 120 also provides social gaming activities in the form of draws. Draws are activities, such as a raffle or lottery or a similar activity, in which one or more users have an opportunity to be randomly selected to win a reward. Social draws do not require active participation by the user. In most cases, all account holding users qualify to participate in at least some draws automatically.

In some cases a draw may provide each user with equal opportunities to win a reward, while in other cases individual users may have greater or lesser chances of success depending on certain criteria. For example, in some embodiments a user may be provided with additional entries into a draw for performing tasks or activities such as viewing advertisements, or for having a predetermined number of friends, etc.

The draws may be weekly, bi-weekly, monthly or annually. The less frequent draws have a higher reward associated with them than the more frequent draws. In some cases, the draws are carried out at a predetermined time. In some other cases, the draws are carried out at a random time.

In various embodiments, the eligibility to participate in various draws is based on a predetermined number of friends associated with a user profile. In some cases, the predetermined number of friend requirement is 0 for all daily draws. In some other cases, a user qualifies to participate in a daily draw if he/she at least has 200 friends.

In some further cases, a user is required to have at least 500 friends for a monthly draw. In some other cases, a user is required to have a friend count between 201 and 499. In some cases, a user is required to have over a 1000 friends to enter a yearly draw.

In some cases, draws do not have a minimum number of friends requirement to determine user eligibility. In such cases, the rewards may be of lower value than the draws with a minimum number of user requirement. In some cases, a user must be present online to actually win a reward from the draw.

Gaming system 120 controls participation in one or more social gaming activities by providing one or more advertisements to the users to view. The users may be provided one or more advertisements to view either before, during or after the commencement of the social gaming activity. In some cases, the user is provided one or more advertisements to view at more than one instance either before, during or after the social gaming activity. The user's participation in an activity may be paused while an advertisement is provided to a user. The user may be provided an advertisement after the social gaming activity but prior to earning credit for the performance in the social gaming activity.

Gaming system 120 communicates with sponsor system 130 to provide advertisements to the users. Advertisements provided by gaming system 120 include multimedia content for promoting brands, products, and services etc. In various cases, advertisers or sponsors, operating one or more of sponsor systems 130 create advertiser activity pages. Advertiser activity pages provide information identifying the advertiser or the sponsor. Advertiser activity pages also include links to social games, draws and advertisements sponsored by the advertisers. Such social games and draws may be used to further promote the advertiser brand, goods and services by, for example, using themes, skins, images, storyline etc. within these activities that resonate with the advertiser products.

Users visiting an advertiser activity page may be able to interact with various aspects of the advertiser activity page. In some cases, users may be able to select “Gimi” associated with an advertiser page, illustrating a user's interest and ‘like’ for that page. This action may be reflected in the user's profile and may be seen by other users on a common page of the social platform. Other users may alternatively or in combination receive a notification informing them of this action.

In some cases, users are able to share advertiser activity pages with other account holders as well as other individuals who are not yet users of the social platform. In various cases, individuals are required to become account holders within gaming system 120 before participating in social gaming activities provided on the advertiser page.

Gaming system 120 may provide advertisements in the form of banner advertisements to the users. These banner advertisements are presented to the user along with the visual display of the social gaming activities. The banner advertisements may be located in the background or on the sides of the social gaming activities, and typically include text, or audio-video content, or a combination of both. Advertisement may also be presented to the viewer in a pop-up window before, during or after the social gaming activity. These advertisements are often static.

Gaming system 120 may also provide advertisements in the form of interactive advertisements to the users. Interactive advertisements are those advertisements that enable an interaction with the viewers to gauge the attentiveness of the viewer towards the advertisement. An interactive advertisement may have interactive and non-interactive portions.

In some cases, interactive advertisements include a survey or a quiz at the end of the advertisement, where the survey or quiz questions are based on the content of the non-interactive portion of the advertisement.

In some other cases, interactive advertisements include a game within the advertisement where the user is expected to actively participate in the game during the duration of the advertisement.

For operators of gaming system 120 and sponsor system 130, interactive advertisements provide an efficient way to track whether the advertisements have been viewed by the users. Interactive advertisements provide operators of the gaming system 120 with opportunities to get businesses interested in sponsoring various aspects of the social gaming activities, such as, types and rewards associated with social games, tournaments and draws etc.

In various embodiments, gaming system 120 provides interactive advertisements to the users, and tracks the extent of user participation for each such advertisement. Gaming system 120 is configured to provide the user participation statistics to the sponsor system 130, and charge the sponsor system 130 accordingly for displaying their advertisements. As the number of users participating in the social gaming activities increases, the social gaming activity operators may be able to provide more advertisements and in turn recoup greater charges from sponsors and advertisers. The enclosed methods and systems may provide social platform operators with effective ways of encouraging additional users to join the social platform and engage in advertisements.

For operators of sponsor systems 130, interactive advertisements integrated with social gaming activities provide an opportunity to businesses to promote their products, services and brands. Operators of sponsor systems 130 also receive quantitative data of user engagement, resulting in a reassurance for the sponsors and advertisers that the money they spend on advertising is spent effectively.

In various cases, users may choose to view advertisements by selecting one or more advertisements from a list of advertisements provided by gaming system 120. In such cases, the user may be provided with rewards such as virtual currency, coupons etc. upon viewing the advertisements. In some cases, the rewards provided to users may depend on certain criteria such as the user's level of engagement in the advertisement. The user level of engagement in an advertisement may be tracked based on the interactive aspects of an advertisement.

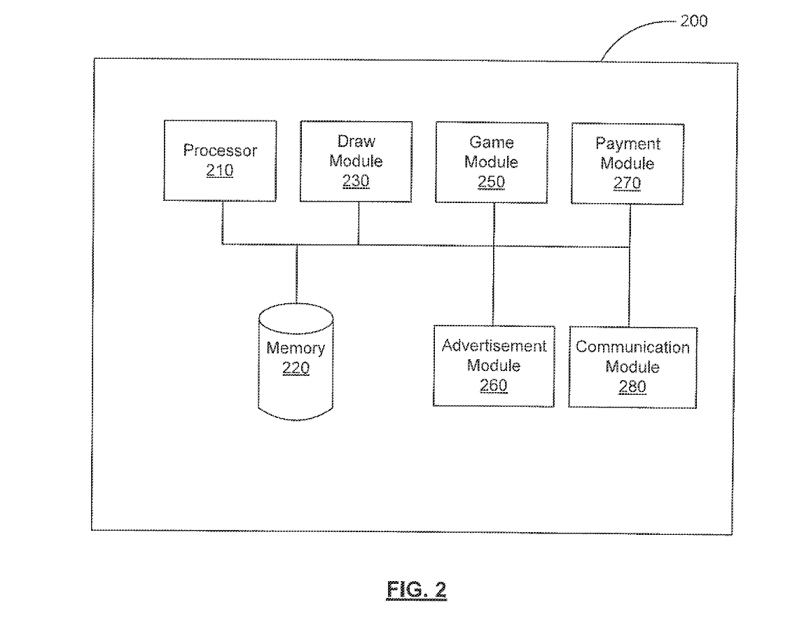

Referring now to FIG. 2, there is illustrated a block diagram of a gaming system 200 which is an example implementation of gaming system 120 of FIG. 1.

Gaming system 200 includes a processor 210, a non-transitory memory 220, a draw module 230, a game module 250, an advertisement module 260, a payment module 270 and a communication module 280. Draw module 230, game module 250 and advertisement module 260 operate within the gaming system 200 to configure processor 210 to provide interactive and non-interactive activities.

Each of the draw module 230, game module 250, advertisement module 260, payment module 270 and communication module 280 is executed by processor 210 within the gaming system 200. In some embodiments (not shown) draw module 230 and game module 250 may be contained within a single module.

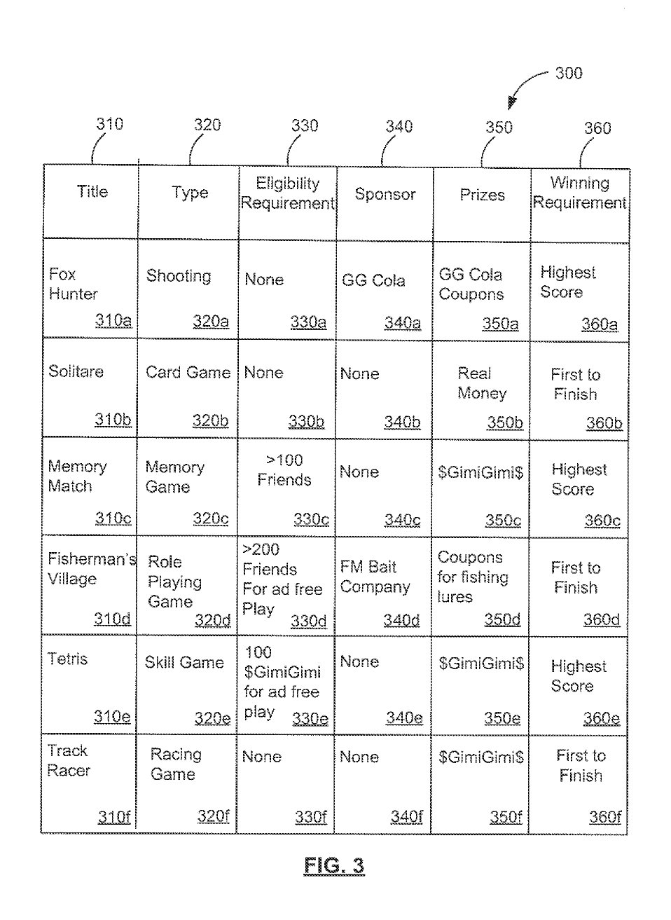

Memory module 220 is a storage module that communicates with the processor 210 and includes one or more relational databases (such as a Structured Query Language (SQL) database), or other suitable data storage devices. The memory module 220 storage devices are configured to host data about the social games, tournaments, draws, advertisements, advertisers and users in the gaming system 200. Examples of the information that may be stored in memory module 220 are illustrated in FIGS. 3, 4, 16, 21, 25, and 27.

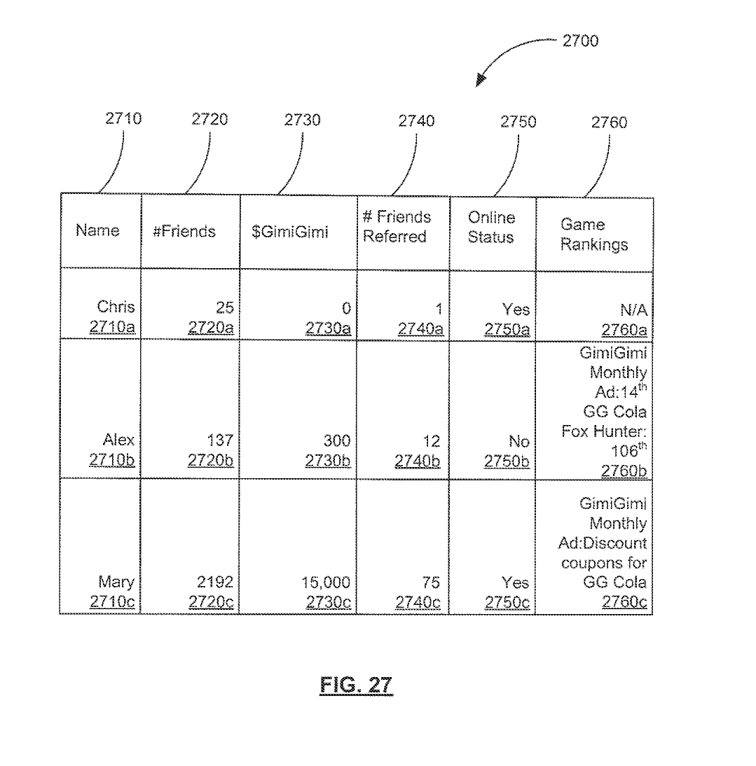

Memory module 220 is configured to store a user profile or database associated with each account holding user. A user profile stores a plurality of information associated with the user and user activities on the gaming system. Some examples of the user information stored in the user database include, but are not limited to: identification information (e.g. name, data of birth, age, location, preferences etc.); number of friends; number of referred friends; advertisement related information, such as names, types and/or number of advertisements watched; social game related information, such as names, types and/or number of social games played; draw related information, such as names, types and/or draws participated in; tournament related information such as names, types and/or number of tournaments played; reward information, such as types and number of rewards won; frequency of online visits; frequency of users befriended on daily, weekly or yearly basis; and level of engagement in interactive advertisements, etc. A user database according to an example embodiment is illustrated in FIG. 27.

Draw module 230 is a storage and processing module configured to manage the operation of one or more user draws in accordance with the teachings herein. Draw module 230 may contain software objects or components executed by the processor 210 to control function of draws within a gaming system, such as gaming systems 100 and 200.

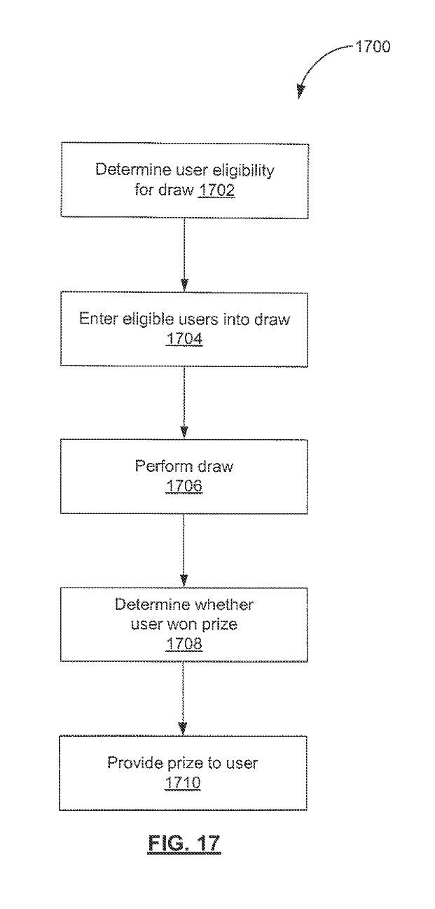

In various embodiments, draw module 230 may contain instructions for configuring processor 210 to determine whether users are eligible for draws, to perform draws, determine whether users have won a prize, and to determine user rewards. Examples of processes that may be performed by draw module 230 are illustrated in FIGS. 17-19, described below.

Game module 250 is a storage and processing module configured to manage the operation of one or more games that may be provided to users in accordance with the teachings herein. Game module 250 may contain software objects or components executed by the processor 210 to control the function of games within the system 100.

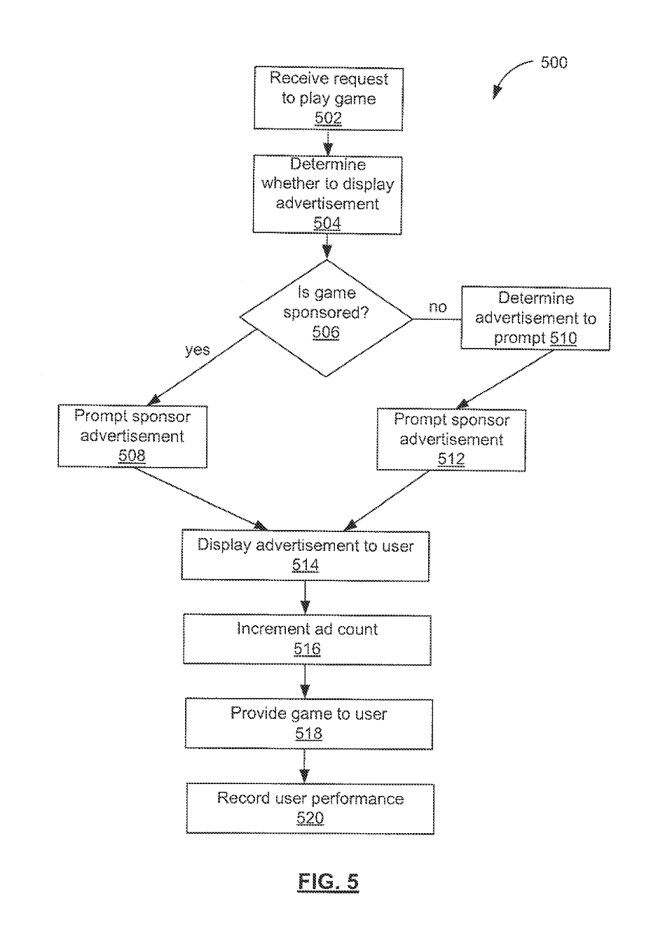

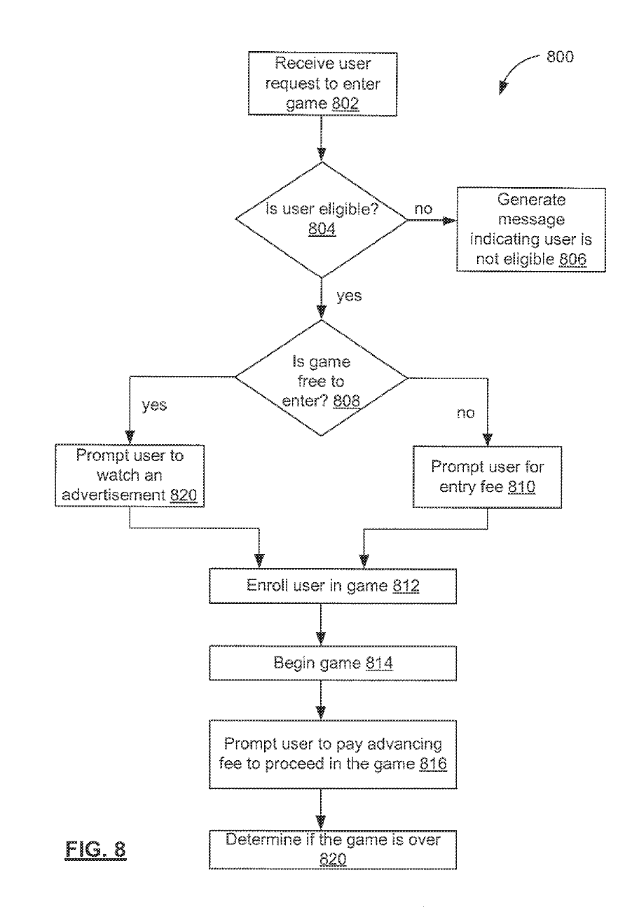

In various embodiments, game module 250 configures the processor 210 to access information in memory module 220 regarding user eligibility requirements for participation in games. In various embodiments, game module 250 configures the processor 210 to provide games to client systems 140 over the network. Examples of processes that may be performed by game module 250 are shown in FIGS. 8-10, described below. Examples of processes that may be performed by game module 250 in collaboration with other modules, such as advertisement module 260, are shown in FIGS. 5-7, described below.

Advertisement module 260 is a storage and processing module configured to manage the operation of one or more advertisements that may be provided to users in accordance with the teachings herein. Advertisement module 260 may contain software components comprising instructions for configuring processor 210 to determine which advertisements may be provided to users. Advertisement module 260 may further configure the processor to provide the advertisements to the users. Examples of processes that may be performed by advertisement module 260 are shown in FIGS. 5-7, described below.

Advertisement module 260 may also contain software components for configuring processor 210 to track the level of engagement of a user when an interactive advertisement is being provided. Advertisement module 260 may also configure the processor 210 to update user profile to reflect the number and types of advertisements viewed by the user and user engagement level.

Payment module 270 is a storage and processing module configured to permit the gaming system 200 to receive payments from, and transmit payments to, sponsor and user systems, such as sponsor system 130 and client system 140, via a network, such as network 110.

Payment module 270 may be a server system that provides an e-commerce application service that authorizes and processes payments made using a credit card, a debit card, an electronic payment system, a smart card, a mobile phone and the like.

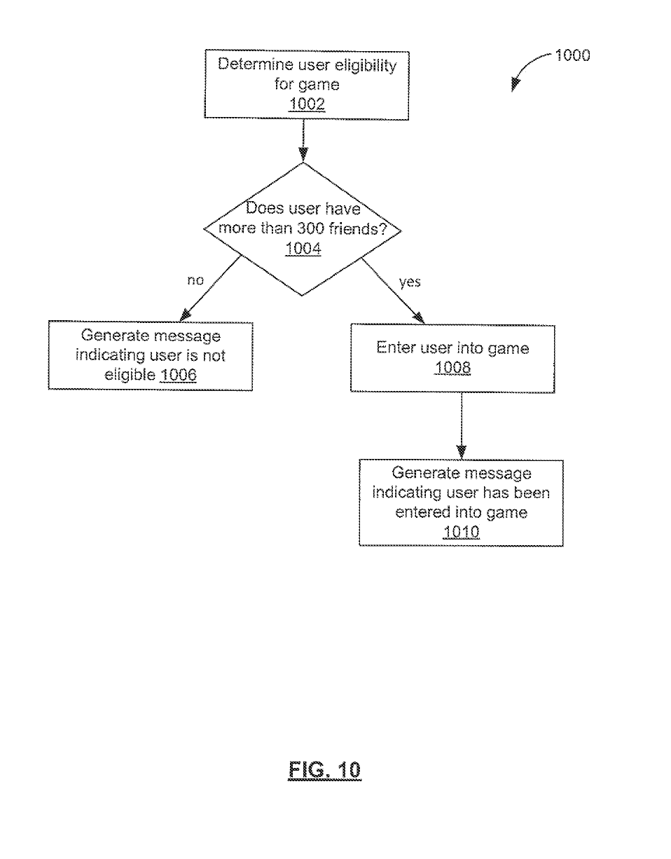

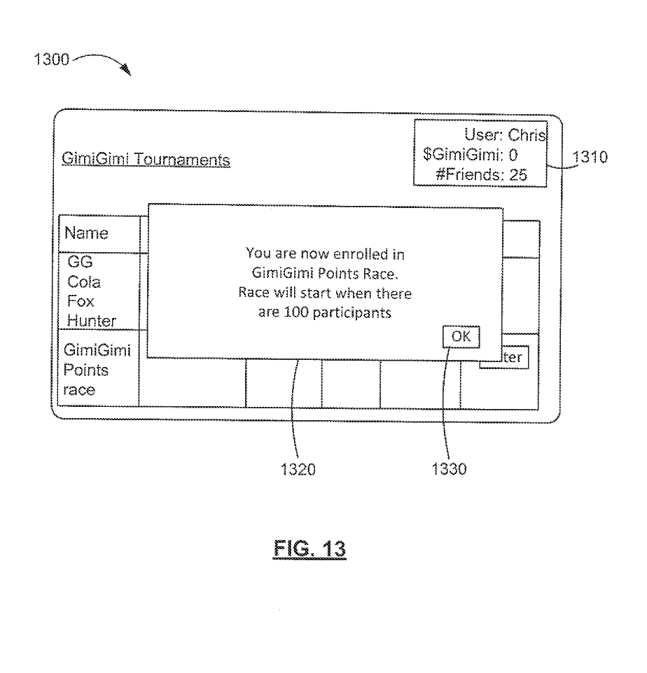

Communication module 280 may include any variety of software or hardware modules facilitating communication over a network. In some embodiments, communication module 280 may allow gaming system 200 to communicate with sponsor systems, such as sponsor system 130, and client systems, such as client system 140, over a network, such as network 110. For example, communication module 280 may be used to transmit messages to client system, when messages are generated in accordance with processes shown in FIGS. 10 and 13 for examples.

Reference is next made to FIG. 3, illustrating a game database 300 according to an example embodiment. Game database 300 is stored in a gaming system, such as memory module 220 of gaming system 200. Game database 300 may be stored in a relational database (such as a Structured Query Language (SQL) database), or other suitable data storage database.

In various cases, game database 300 contains information about the games stored in a gaming system, such as, but not limited to, game title 310, game type 320, game eligibility requirement 330, game sponsor 340, game prize 350, and game winning requirement 360. In some other cases, game database 300 may include more or less information about games stored in the gaming system. For example, game database 300 may store information including, but not limited to, developer of the game, updates to the game, highest game scores, and the like.

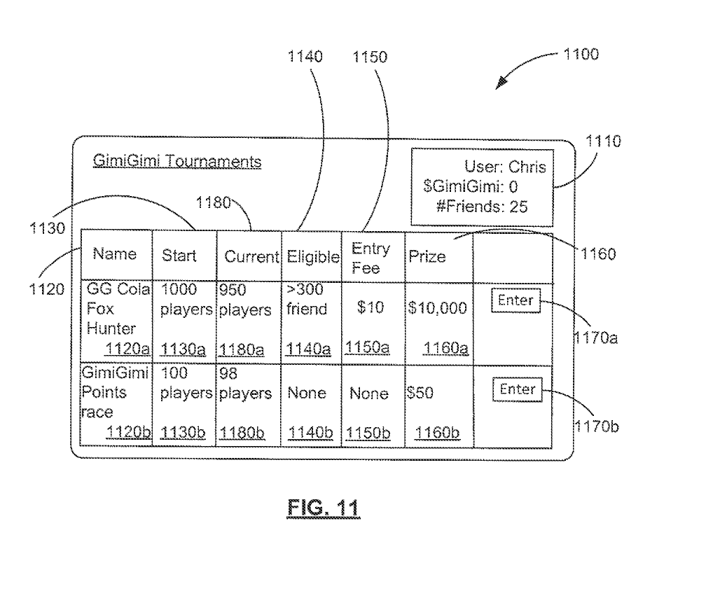

Game title 310 stores the name or title of a game as presented to a user. Game titles 310a-310f provides some examples of game titles according to an example embodiment. Game title 310 may be accessed by various modules of a gaming system, such as game module 250 of gaming system 200, in order to provide the user with the titles of games contained within the system. In various cases, game title 310 may be displayed to a user in a browser in a manner similar to the browser shown in FIG. 11.

Game type 320 may represent the type of a game. Social games may be divided into broader categories including, but not limited to, shooting games 320a, card games 320b, memory games 320c, role playing games 320d, skill games 320e, racing games 320f, etc. Game type 320 may be accessed by various modules of a gaming system, such as game module 250 of gaming system 200, to present to the user a list of games based on game types. Game types 320a-320f provide some examples of game types, however it will be understood that game type 320 may also include other categories or types of games. In some cases, a game may be associated with one or more game types simultaneously.

In some embodiments, game type 320 segregates social games into another set of broader categories, including, but not limited to, single-player games, multi-player games, finite-duration games, unlimited-duration games, and the like,

Game eligibility requirement 330 provides the eligibility requirements that a user must satisfy in order to participate in a game. Game eligibility requirements 330c-330e illustrate some examples of eligibility requirements in accordance with one example embodiment. Game eligibility requirements may specify requirements in terms of minimum number of friends, number of advertisements to be viewed, and amount of virtual currency associated with a user profile, etc. In some cases, no eligibility requirements are specified and all individuals having an account within a gaming system, such as gaming system 100, are eligible to participate in the social games, as illustrated in 330a, 330b and 330f.

Game sponsor 340 identifies the sponsor of the social game, if any. Game sponsors 340a and 340d illustrate examples of sponsors in accordance with an example embodiment. In some cases, a social game is not sponsored by anyone, as illustrated in 340b, 340c, 340e and 340f. A game may be sponsored by one or more advertisers concurrently. Alternatively, in some other cases, each game can have only one sponsor.

In various cases, identification of the game sponsor 340 is used by the gaming system to determine which advertisements should be provided to a user before, during and/or after the social game or other social activities.

Game prize 350 indicates the reward associated with a social game. Game prizes 350a-350f illustrates certain rewards associated with certain social games according to one example embodiment. Rewards may include virtual currency, as illustrated in 350c, 350e-350f, coupons for sponsor products and/or services, as illustrated in 350a and 350d, real money, as illustrated in 350b, and the like.

Winning requirement 360 specifies requirements regarding how a winner is determined. In some cases, a winner is the user with the highest score, as illustrated in 360a, 360c and 360e. In some other cases, a winner is the first user to successfully finish the game, as illustrated in 360b, 360d and 360f.

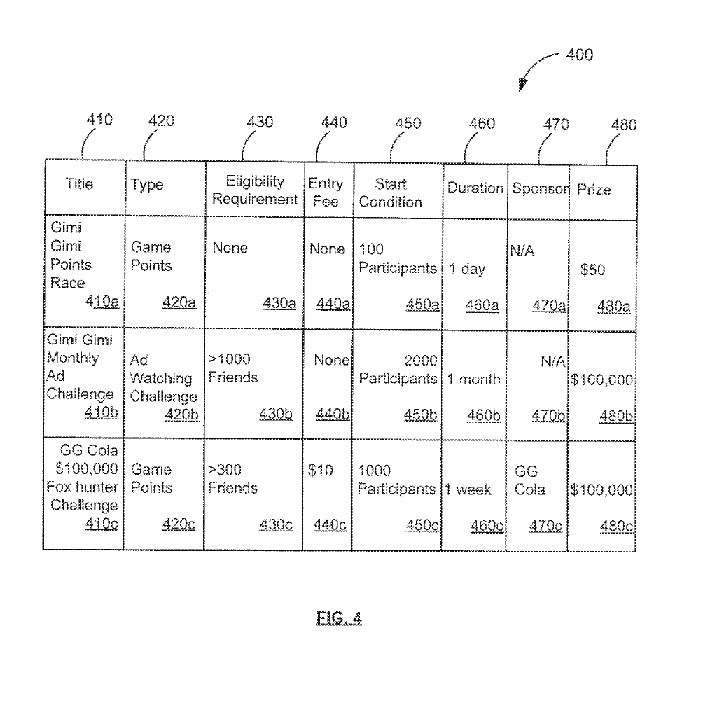

Reference is next made to FIG. 4, which illustrates a tournament database 400 according to an example embodiment. Tournament database 400 may be stored in various modules of a gaming system, such as the memory module 220 of gaming system 200. In some embodiments, tournament database 400 may be stored in a relational database (such as a Structured Query Language (SQL) database), or other suitable data storage databases.

Tournament database 400 may contain information about the tournaments stored in the gaming system 200. Such information includes categories, such as, but not limited to, tournament title 410, tournament type 420, tournament eligibility requirement 430, tournament entry fee 440, tournament start condition 450, tournament duration 460, tournament sponsor 470, and tournament prize 480. In other example embodiments, tournament database 400 may store other information, such as, for example, tournament updates, tournament highest scores, etc.

Tournament title 410 is the name of the tournament that is provided to the user. Tournament titles 410a-410c provide some examples of tournaments. For example, a Gimi Gimi points race 410a tournament rewards a user who earns the most points playing any social game in one day. A Gimi Gimi monthly ad challenge 410b tournament rewards a user who watches the most advertisements in one month. A GG Cola $100,000 Fox hunter challenge 410c tournament rewards a user who earns the most points in one week in Fox hunter challenge game. In various embodiments, tournament title 410 is displayed to a user in a browser in a manner similar to the browser shown in FIG. 11.

Tournament type 420 may represent the type of a tournament stored in that database section. In various embodiments, tournament type 420 may be accessed by various gaming system 120 modules such as the game module 250 to present to the user lists or pages with tournaments categorized together based on type. Types 420a-420c provide some examples of tournament types, however it will be understood that tournament type 420 may also include a variety of other types. In some cases, a tournament may be associated with one or more tournament types simultaneously.

Tournament eligibility requirement 430 provides the requirements that a user must satisfy in order to be eligible to participate in a tournament. Tournament eligibility requirements 430a-430c illustrates some examples of eligibility requirements. In most cases, a user qualifies to participate in a tournament based on the number of friends, as illustrated in 430b and 430c. In some other cases, there is no eligibility requirement to participate in a tournament, as illustrated in 430a. The latter tournaments may have a lower value reward associated with it. It will be understood that tournament eligibility requirement 430 may also include other criteria such as, for example, a user's level of virtual currency, the user's provision of an entry fee, the number of friends a user has referred to the gaming system 120, and the like.

Tournament entry fee 440 may contain the entry fee that must be provided by a user in order for the user to participate in the tournament. Tournament entry fees 440a-440c provide some examples of entry fees. In some cases, a user can enter a tournament without any entry fee, as illustrated in 440a and 440b. In some other cases, a user has to pay an entry fee in the form of virtual currency, as illustrated in 440c. It will be understood that tournament entry fee 440 may include any other type and quantum of entry fee, such as entry fees based on real currency, user watched a certain number of advertisements, etc.

Tournament start condition 450 may contain information regarding the conditions necessary in order for a tournament to begin or for a tournament to be provided to a user. Tournament start conditions 450a-450c illustrates some examples of start conditions. In most cases, the tournament start conditions are based on the number of participants eligible for the tournament, as illustrated in 450a-450c. In some other cases, a tournament start condition may be described in terms of a prescribed time. In such cases, a tournament starts at the prescribed time, which is pre-defined and may be a time of the day, or a day of the month, or a couple of pre-defined weeks etc. In some cases, a tournament may be initiated upon request by a user without any start conditions.

Tournament duration 460 may contain information regarding the duration of a tournament. In some cases, a tournament has a pre-defined duration, as illustrated in 460a-460c. In some other cases, tournament duration may be specified in terms of end conditions attached to it, including, but not limited to, a prescribed number of advertisements watched within a prescribed duration, a prescribed amount of progress within the social activity, a prescribed game score and the like.

Tournament sponsor 470 indicates whether the game is sponsored by a particular advertiser or sponsor, and identifies that sponsor. Game sponsors 470a-470c provide examples of sponsors in accordance with an example embodiment. In some cases, a tournament may be sponsored by more than one advertiser concurrently. In some other cases, a game may be sponsored by only one advertiser, as illustrated in 470c. In some further cases, a game may not be sponsored by any advertisers, as illustrated in 470a and 470b.

Tournament sponsor field 470 may be used by the gaming system to determine which advertisements may be provided to a user before, during and/or after the tournament.

Tournament prize 480 identifies the reward associated with a tournament. Tournament prizes 480a-480c provide some examples of prizes according to an example embodiment. Tournament prize 480 may also include information about adjusting the prize to be awarded for participation in a tournament according to other criteria, such as the number of friends of the user or the number of participants in the tournament, etc.

In most cases, a tournament database also provides information regarding the criteria for determining a winner of a tournament. Such criteria may be based on conditions such as, but not limited to, whether a user has placed first in the tournament, whether the user has achieved a high score, etc.

Reference is now made to FIG. 5, which illustrates a process flow 500 for a method of providing a social gaming activity in accordance with an example embodiment. The process 500 is carried out by the various modules of a gaming system, such as the game module 250 or the advertisement module 260 of the gaming system 200.

At 502, a gaming system receives a request to play a game. The request may be received by the game module 250 of the gaming system 200. The request is initiated by a user at the client system, such as client system 140. This user request may then be transmitted from the client system to the gaming system via a network, such as network 110. In some cases, the gaming system may provide a list of active social games to a user, and the user may request to play a game by clicking on the game from the list.

At 504, a determination is made whether to display an advertisement. In some cases, the game module of the gaming system may request information from a game database, such as game database 300, to determine whether an advertisement is to be displayed. In some cases, the game module, such as game module 250, will alert advertisement module, such as advertisement module 260, that an advertisement may be displayed.

At query 506, the gaming system initiates a query whether the social game is sponsored. In some cases, determining whether a game is sponsored may include the game module 250 retrieving information regarding the game sponsor information 540 from the game database 300.

If query 506 returns true, the gaming system may prompt an advertisement corresponding to the game's sponsor at 508. In some cases, gaming system may direct the user to a sponsor page to watch an advertisement on that page. In some other cases, the gaming system will display the sponsor advertisement on the social gaming platform. In such cases, the gaming system may communicate with the sponsor system, such as sponsor system 130, to receive the advertisement for displaying to the user. In some other cases, the gaming system stores a wide variety of advertisements within memory, such as memory 220, and only receives advertisement identifying information, such as advertisement type and advertisement title, from the sponsor system. The gaming system then retrieves the corresponding advertisement and displays it to the user.

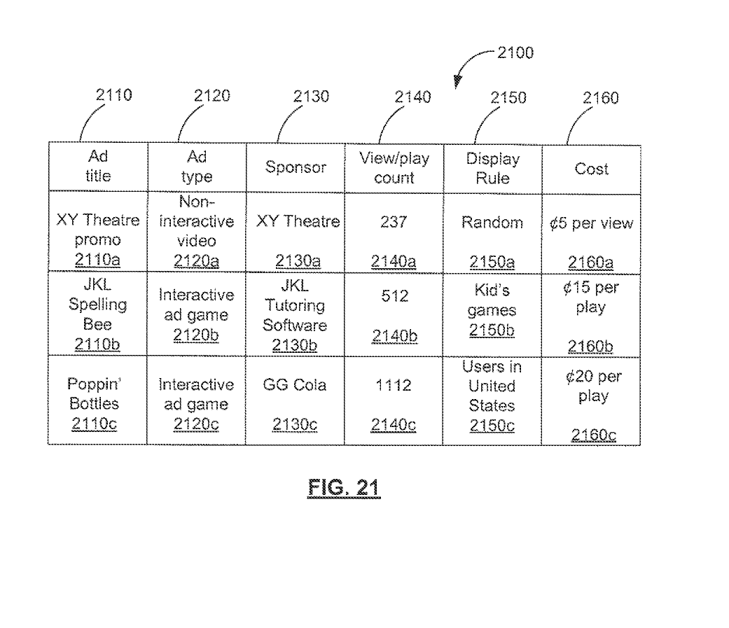

If query 506 returns false, gaming system determines which advertisement to display at 510. In some cases, the gaming system may make this determination based on certain rules, such as ad display rules 2150 of FIG. 21. In some cases, the game module may select an advertisement at random. In some other cases, the game module may prompt an advertisement based on factors, including, but not limited to, the type of the social game, age of the user, sex of the user, the user's geographic location, the advertisements the user has previously viewed, information about the user's engagement in previous advertisements, the time of day, the number of friends associated with the user profile, and a combination of these. Once game module 250 has selected the advertisement to display to the user, the selected advertisement is prompted at 512.

Once the gaming system has prompted an advertisement at either 508 or 512, the prompted advertisement is displayed to the user at 514.

Once the advertisement has been displayed to the user, the gaming system records the name and type of advertisement displayed to the user at 516. This information may be used by the gaming system to charge the sponsor of the advertisement accordingly. The gaming system may also use this information to determine which advertisement was displayed to the user recently and which advertisement should be provided to the user in the future. In some cases, the advertisement displayed to the user is an interactive advertisement. In such cases, gaming system keeps track of the level of user engagement with the advertisement. In cases where the advertisement displayed to the user is a non-interactive one, the user engagement with the advertisement is not tracked.

At 518, the game module provides the requested social game to the user. At 520, the game module records the user performance in the game. User performance may be stored in various modules of the gaming system such as the memory 220. The user performance is used to determine the winner of the social game.

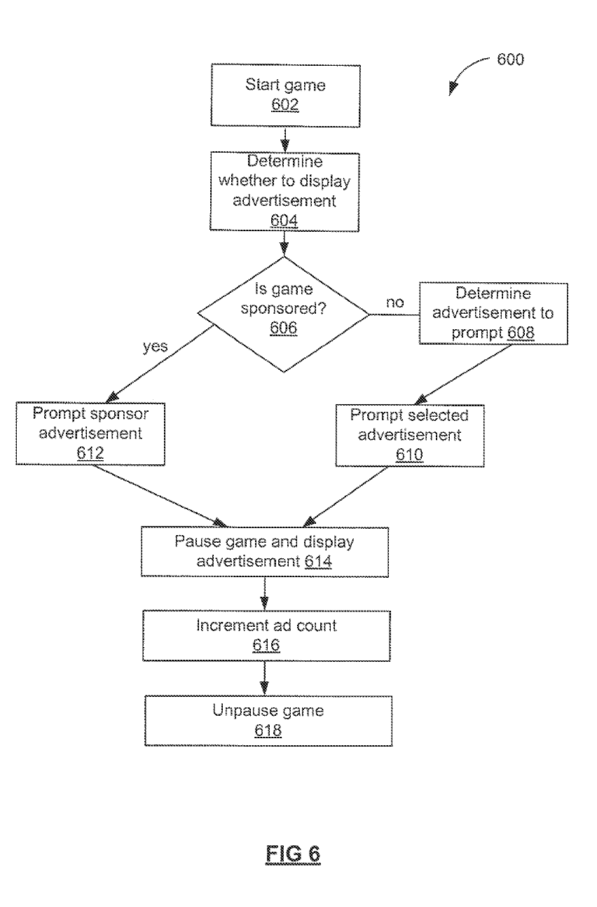

Referring now to FIG. 6, which illustrates a process flow 600 for a method of providing a social gaming activity in accordance with another example embodiment. The process 600 is carried out by the various modules of a gaming system, such as the game module 250 or the advertisement module 260 of the gaming system 200.

At 602, a game module starts a social game. Starting a social game includes providing the game to a client system, such as client system 140, over a network, such as network 110. In some cases, a game is started in response to a communication received from a client system. In some other cases, a game is started in response to an initiation command generated by the gaming system.

At 604, the gaming system determines whether to display an advertisement. In some cases, the gaming module 250 may retrieve game information stored in the game database 300 to determine whether an advertisement is to be displayed. In some other cases, determining whether to display an advertisement may depend on a variety of factors such as, but not limited to the number of friends of the user, how recently the user has viewed a previous advertisement, the length of the previous advertisement viewed, whether the user has paid an entry fee, and the like.

Once it is determined that an advertisement is to be displayed, the gaming system queries whether the social game is sponsored at 606. Acts 606, 608, 610 and 612 of process flow 600 are analogous to steps 506, 508, 510 and 512 of process flow 500.

At 614, the game module pauses the game that is currently being provided to the user and displays the prompted advertisement to the user. Once the advertisement has been displayed to the user, at 616 the gaming system updates the advertisement count. This act is analogous to 514 of process flow 500.

At 618, the social game is un-paused so that the player continues to play the game.

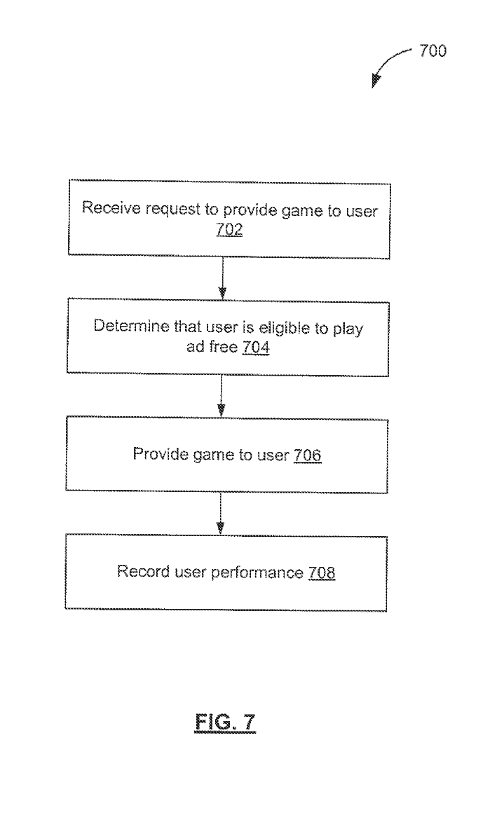

Reference is next made to FIG. 7, which illustrates a process flow 700 for a method of providing a social gaming activity in accordance with another example embodiment. The process 700 is carried out by the various modules of a gaming system, such as the game module 250 of gaming system 200.

At 702, the gaming system receives a request to provide a game to a user. This act is analogous to act 502 of process flow 500.

At 704, the gaming system determines that the user is eligible to play the game without being shown an advertisement. In some cases, a user may be eligible to play a game without advertisements if the user has paid an entry fee to play the game. In some other cases, a user may be eligible to play a game without advertisements if the reward associated with the game is small. The game module may determine whether the social game can be provided without an advertisement based on game eligibility requirements, such as game eligibility requirement 330 of FIG. 3.

At 706, the game module provides the game to the user. The game is provided without any advertisements or interruptions. At 708, the gaming system records the user's performance in the game.

Reference is next made to FIG. 8, which illustrates a process flow 800 for a method of providing a social gaming activity in accordance with another example embodiment. The process flow 800 is carried out by the various modules of a gaming system, such as the game module 250 of gaming system 200. The process flow 800 illustrates a process for determining user eligibility to participate in a game, and determining whether a user is free to enter the game.

At 802, the gaming system 120 receives a request from a user to participate in a social game. The request is initiated by a user at a client system and a user request is transmitted from the client system to a gaming system via a network.

At 804, the gaming system queries whether the user is eligible to participate in the game. The gaming system may determine whether the user meets the eligibility requirement based on the criteria for eligibility recorded in a game database, such as the game database 300, and information specific to the user profile. An example embodiment of this determination with regard to eligibility is illustrated in process 1000 shown in FIG. 10, described further below.

Some factors affecting the user eligibility to participate in a game include, but are not limited to, virtual currency associated with user profile, number of friends associate with user profile, number of referred friends associated with user profile, and the like.

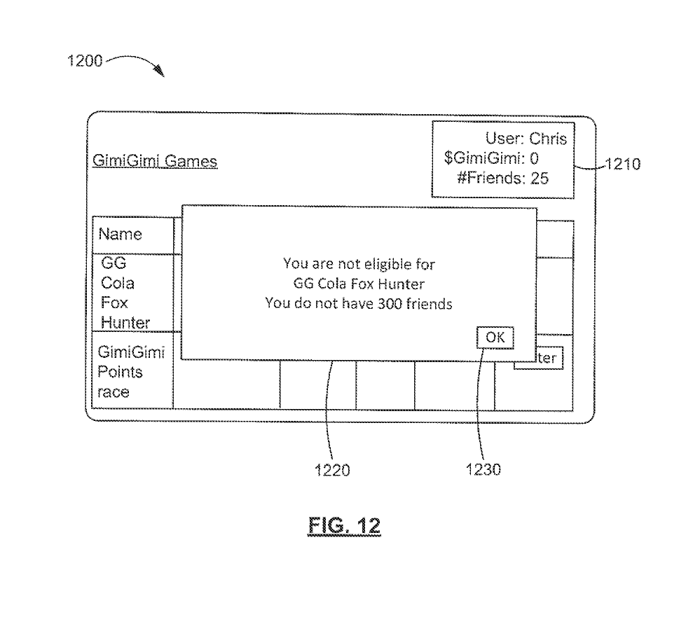

If query 804 returns false, the game module generates a message indicating that the user is not eligible to participate at 806. An example of a message that may be displayed to a user in an example embodiment is shown in FIG. 12. In some cases, the user is only notified that he/she does not meet the game eligibility requirement. In some other cases, reasons regarding why the user does not meet the game eligibility requirement are also provided.

If query 804 returns true, the user is eligible to enter the game. The game module then determines whether the game is free to enter at 808. The game module may determine that the user is free to enter based on a game database, such as the game database 300.

If query 808 returns false, the game module prompts the user for the entry fee at 810. The entry fee required may be in the form of virtual currency. The user entry fee is processed by a payment module, such as the payment module 270 of gaming system 200, which confirms whether the user has paid the entry fee. Once the gaming system has received the entry fee and it has been processed by payment module, the game module enrolls the user in the game at 812.

If query 808 returns true, the user is prompted to watch an advertisement at 820. The gaming system determines which advertisement to display to the user based on a game database, such as the game database 300. The advertisement may be interactive or non-interactive. Once the advertisement is viewed in the case of a non-interactive advertisement, or the level of user participation is acceptable in the case of an interactive advertisement, the game module enrolls the user in the game at 812. In some cases, the game module 250 may update the entry in the game database 300 corresponding to the game in question to reflect the number of users currently enrolled to participate in the game.

After the user has been enrolled in the game, the gaming system begins the game at 814. Beginning a game may entail providing instructions for configuring a processor to provide a game to the client system over a network. In some embodiments, a game may be started in response to a communication received from the client system. In some other embodiments, a game may be started based on other factors, such as, the minimum number of player requirement is met.

At 816, the user is prompted to pay an advancing fee to proceed in the game. This act may be an optional act depending on the type of game being played. The gaming system determines whether to seek an advancing fee payment from the user based on a game database, such as game database 300. The payment module processes the advancing fee payment. Once the advancing fee has been processed, the user is permitted to proceed in the game.

At 820, the gaming system determines if the game is over. In various cases, the gaming system determines if the user has won the game. To determine whether the user has won the game, the gaming system may monitor the user performance and compare it to winning requirements stored in a game database.

In various cases, the gaming system is configured to provide the user with a reward. A reward may include real currency, virtual currency, coupons and/or free goods and services. The rewards may be sponsored by the operators of the gaming system, operators of the sponsor system, or a combination of both.

In some cases, the user is notified that the user has won a reward. The type of reward may also be specified. In some other cases, the user is provided with downloadable coupons that the user may click on to download in the client system. In some further cases, the user is provided a list of reward options of equal value form which the user may select the preferred one.

In various cases, the winner and reward information is used to update the game database as well as the user database.

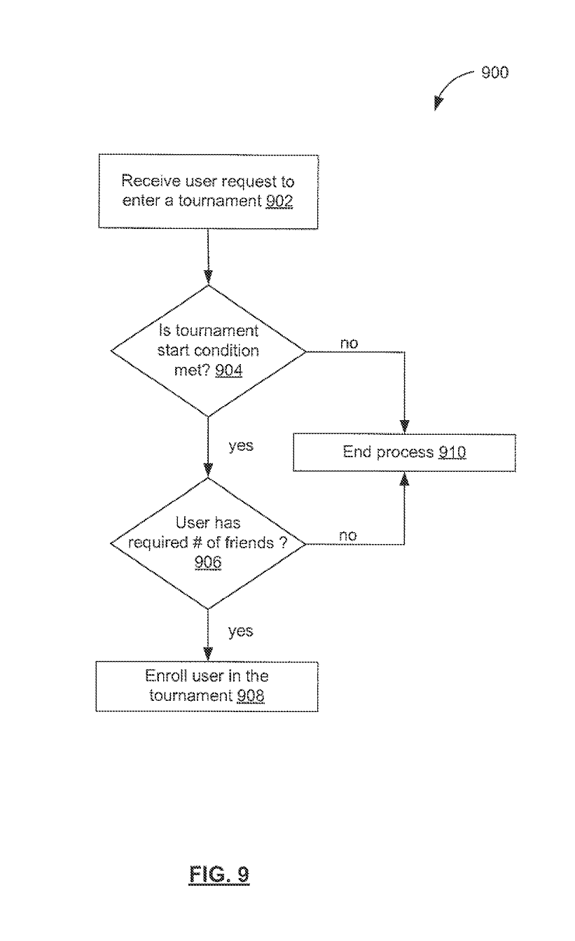

Reference is now made to FIG. 9, which illustrates a process flow 900 for a method of providing a social gaming activity in accordance with another example embodiment. The process flow 900 is carried out by the various modules of a gaming system, such as the game module 250 of gaming system 200. The process flow 900 illustrates a process for determining user participation in a tournament.

At 902, the gaming system receives a user request to enter a tournament. FIG. 11 illustrates an example embodiment of a screenshot of a display interface shown to a user requesting to enter a tournament.

At 904, the gaming system determines whether the start condition for the tournament is met. In various cases, the start condition of the tournament specifies the minimum number of participants required to be enrolled in the tournament before the tournament can start. The gaming system may make this determination based on a tournament database, such as tournament database 400.

If the start condition of the tournament is not met, the process ends at 910. In some cases, the user may be notified that the tournament will only start when the start conditions are met. An example embodiment of such a notification is illustrated in FIG. 13.

If the minimum start conditions of the tournament are met, the gaming system determines, at 906, if the minimum number of friends requirement associated with the tournament is met.

If the minimum friend requirement is not met, the process ends at 910. FIG. 12 illustrates an example screen shot notifying the user that the user does not qualify to participate in the tournament since the minimum friend requirement is not met.

At 908, the user is enrolled in the tournament if the minimum friend requirement is met. In some cases, the user is notified that the user has been enrolled in the tournament. In some other cases, the user is further informed of the tournament start time, tournament duration and/or tournament rewards.

Reference is now made to FIG. 10, which illustrates a process flow 1000 for a method of providing a social gaming activity in accordance with another example embodiment. The process flow 1000 is carried out by the various modules of a gaming system, such as the game module 250 of gaming system 200. The process flow 1000 illustrates the process for determining whether a user is eligible to participate in a game.

At 1002, the gaming system initiates the process of determining user eligibility for a social game. The gaming system initiates this process in response to a user request to participate in a game. In the example embodiment illustrated herein, the user eligibility requirement is that a user should have a minimum of 300 friends to be eligible to participate in the game. The gaming system may determine the eligibility criteria based on a game database, such as game database 300.

At 1004, the gaming system determines whether the user has 300 or more friends. The gaming system determines whether a user has met the eligibility criteria based on the information included in a user database, where the user database is stored in a memory module, such as memory module 220 of FIG. 2. An example of a user database is illustrated in FIG. 27.

If query 1004 returns false, the gaming system generates a message at 1006 indicating that the user is not eligible to participate in the game. The communication module of gaming system transmits this message to the client system via a network. A message that may be displayed to a user according to an example embodiment is shown in FIG. 12.

If query 1004 returns true, then gaming system enters the user into the game at 1008. In various cases, the game module updates the game database to increment the number of players currently playing the game. The game module also updates the user profile to record the name, number and type of social game the user has played.

Once the user has been enrolled in the game, the gaming system may generates a message for the user at 1010 indicating that the user has been enrolled in the game.

Reference is made to FIG. 11, which illustrates a display interface 1100 of a gaming system according to one embodiment. The display interface 1100 is configured by the gaming system for display to the users of the gaming system. The display interface 1100 illustrates a screen shot that is provided to a user when the user wishes to enter a tournament.

Information box 1110 identifies the user who wishes to participate in a tournament. Gaming system configures the information box 1110 to display information based on the user profile stored in a memory module of the gaming system. As illustrated, the information box 1110 displays the name associated with the user profile, amount of virtual currency associated with the user profile and number of friends associated with the user profile. In some other cases, additional information form the user profile may be displayed in the information box 1110. In some further cases, less information, such as, only the name associated with the user profile, may be displayed in the information box 1110.

In this example embodiment, the display interface 1100 is configured to display a list of active tournaments. In some other cases, only the tournaments the user is eligible to participate in are displayed to the user.

Display interface 1100 indicates the tournament name 1120, start conditions 1130, current conditions 1180, eligibility requirement 1140, entry fee 1150 and associated reward 1160. In other embodiments, the user may be presented with different information in the display interface 1100.

As illustrated, a user is displayed two tournaments 1120a and 1120b that the user is eligible to participate in. The tournament 1120a is a game based tournament where the user's chances of winning the tournament are based on user's performance in the ‘Fox Hunter’ game. The tournament 1120b is a tournament where the user's chances of winning are based on the number of points collected by the user while participating in various activities on the social gaming platform. These tournaments do not require the user to carry out any additional actions than the ones the user is already doing on the social gaming platform.

The user is provided information with respect to entry fee 1150a and 1150b, and rewards 1160a and 1160b for each tournament. These entries may have the effect of getting the user interested in the tournaments since the user gets the opportunity to see the huge rewards the user may win in exchange for no fee or a minimal entry fee.

In addition, the display interface 1100 provides the eligibility requirements 1140a and 1140b for each tournament. The tournament eligibility is based on the number of friends of the user. This information provides the users an opportunity to analyze for themselves whether or not they qualify to participate in the tournament. If a user notices that he/she does not meet the eligibility requirement, the user may be motivated to add pre-existing account holders as friends, or refer non-account holders to the social gaming platform.

In cases where the tournament is game based, the eligibility requirement for the tournament incorporates the eligibility requirement for the corresponding social game.

The display interface 1100 also provides information regarding start and current conditions of the tournament. Start conditions 1130a and 1130b indicate the conditions that need to be met before the tournament begins. Current conditions 1180a and 1180b indicate whether or not the start conditions have been met. Displaying the start and current conditions to the user also motivates the user to add or refer more friends if the user is short of the minimum number of friends required for eligibility. Information about the start and current conditions may influence the user's decision to add or refer more friends since if the difference between the start and current conditions is very small, the user may expedite the adding and/or referring actions.

Display interface 1100 also provides an interactive area within the interface, such as buttons 1170a and 1170b, which allows a user to select the tournament the user is interested in participating in. Display interface 1100 may provide other types of interactive areas, other than buttons, to enable the user to make a selection.

Reference is made to FIG. 12, which illustrates a display interface 1200 of a gaming system according to another embodiment. The display interface 1200 is configured by the gaming system, such as gaming systems 100 and 200, for display to the users of the gaming system. The display interface 1200 illustrates a screen shot that is provided to a user when the user selects a tournament, such as from the tournaments of FIG. 4, where the user is not eligible to enter.

Display interface 1200 includes an information box 1210, which is analogous to information box 1110 of FIG. 11. Display interface 1200 also includes a message box 1220 that notifies the user that the user has attempted to enter a tournament for which the user is not eligible. The message box 1220 is triggered when the user selects a tournament, such as a tournament from FIG. 11, for which the user does not meet the eligibility requirement. In cases where the tournament is game based, the message box 1220 may be triggered where the user does not meet the eligibility requirement of the social game.

As illustrated, the message box 1220 provides the reason for failure to participate in the tournament. In some other cases, the message box 1220 may only notify the user of lack of eligibility without specifying the reason.

Display interface 1200 includes an interactive button 1230 which is provided to receive acknowledgement from the user that the user has viewed the message box 1220.

Reference is made to FIG. 13, which illustrates a display interface 1300 of a gaming system according to another embodiment. The display interface 1300 is configured by the gaming system, such as gaming systems 100 and 200, for display to the users of the gaming system. The display interface 1300 illustrates a screen shot that is provided to a user when the user successfully enters a tournament.

Display interface 1300 includes an information box 1310, which is analogous to the information box 1110 of FIGS. 11 and 1210 of FIG. 12.

Display interface 1300 also includes a message box 1320 which notifies the user that the user has successfully entered a tournament. Message box 1320 may also provide additional information, such as the start conditions of the tournament, as illustrated. The additional information may also include other information, such as the start time of the tournament, the current condition of the tournament, the additional number of participants required to start the tournament, the reward associated with the tournament, etc.

In cases where the start condition of the tournament is met, no additional information, other than notifying the user that he/she has successfully entered the tournament, is provided to the user.

Display interface 1300 also includes an interactive button 1330, which is analogous to button 1230 of FIG. 12.

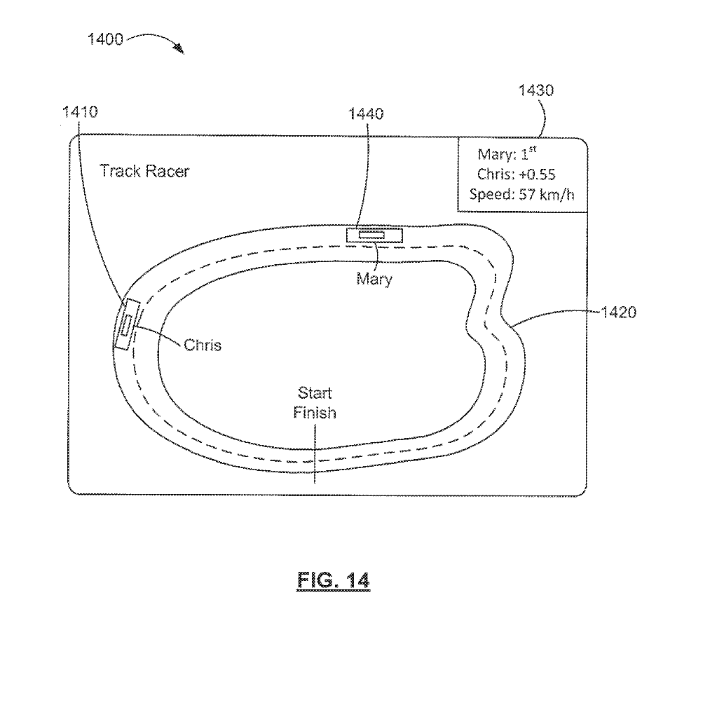

Reference is made to FIG. 14, which illustrates a display interface 1400 of a gaming system according to another embodiment. The display interface 1400 is configured by the gaming system, such as gaming systems 100 and 200, for display to the users of the gaming system. The display interface 1400 illustrates an example screen shot of a multi-player racing game in which the user is participating.

Display interface 1400 includes a game information box 1430 that identifies information, such as, the user, the first place holder in the social game and the user speed. In other embodiments, game information box 1430 of the display interface 1400 may be configured to provide other game specific information.

Display interface 1400 also displays a user car 1410 that is controlled by a user. The user may use the input means of the client system to provide commands to control the user car 1410. In some other cases, the display interface 1400 may include controllers, such as, buttons, that the user may select to control the user car 1410.

As illustrated, the display interface 1400 includes a bird's-eye view of a track 1420 in which the user is racing. The display interface 1400 may be configured to switch between multiple views relevant to the racing game, such as, for example, the display interface 1400 may be configured to switch between a bird's-eye view of the track and a driver's view from inside the car. In some cases, the display interface 1400 may permit the user to select different views or switch between different views.

In one view, the display interface 1400 includes a race car 1440 of the participant leading the race. In some other view, the display interface 1400 shows cars of all other participants. In some further view, the display interface 1440 shows all the cars visible from the driver view of the user car 1410.

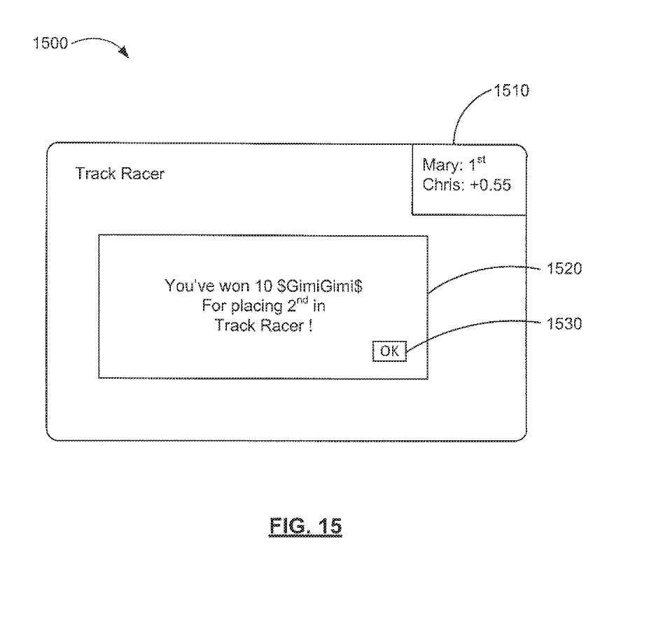

Reference is made to FIG. 15, which illustrates a display interface 1500 of a gaming system according to another embodiment. The display interface 1500 is configured by the gaming system, such as gaming systems 100 and 200, for display to the users of the gaming system. The display interface 1500 illustrates an example screen shot of a multi-player racing game in which the user has earned a reward.

Display interface 1500 includes a game information box 1510 analogous to game information box 1430. Display interface 1500 also includes a message box 1520 notifying the user that the user has won virtual currency for placing second in the social game. Display interface 1500 also includes a button 1530 analogous to button 1330 of FIG. 13 and button 1230 of FIG. 12.

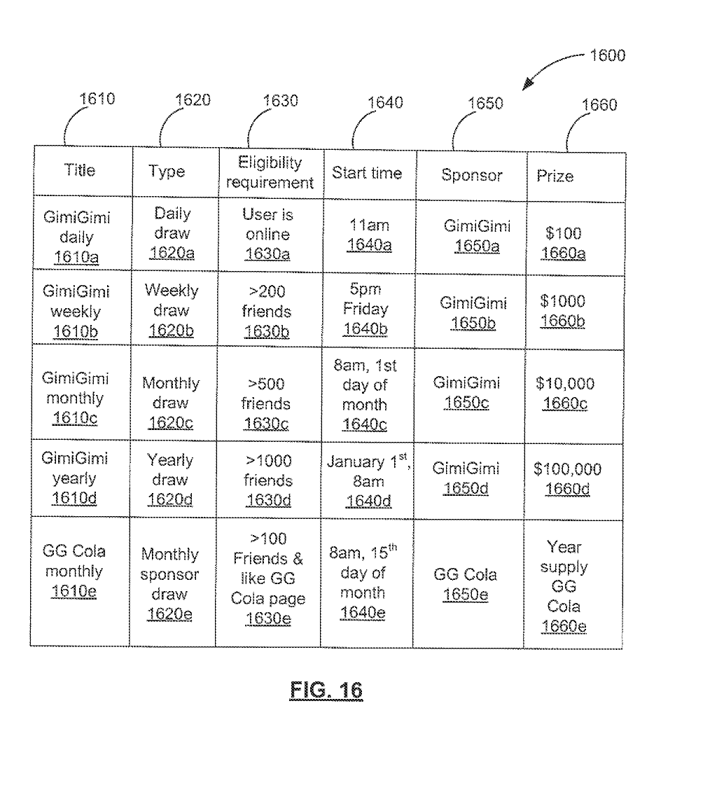

Reference is made to FIG. 16, which illustrates a draw database 1600 according to an example embodiment. Draw database 1600 is stored in a gaming system, such as memory module 220 of gaming system 200. Draw database 1600 may be stored in a relational database (such as a Structured Query Language (SQL) database), or other suitable data storage database.

In various cases, draw database 1600 contains information about the various draws stored in a gaming system, such as, but not limited to, draw title 1610, draw type 1620, draw eligibility requirement 1630, draw time 1640, draw sponsor 1650, and prizes 1660. In some other cases, draw database 1600 may include more or less information about the draws stored in the gaming system. For example, draw database 1600 may store information including, but not limited to, developer of the draws, updates to the draws, draw winners, and the like.

Draw title 1610 identifies the name or title of the draw as it would be presented to a user, and draw type 1620 identifies the type of each draw. The gaming system provides draws that are daily draws 1620a, such as GimiGimi daily draw 1610a, weekly draws 1620b, such as GimiGimi weekly draw 1610b, monthly draws 1620c and 1620e, such as GimiGimi monthly draw 1610c and GG Cola monthly draw 1610e, and yearly draws 1620d, such as GimiGimi yearly 1610d. As illustrated, one or more draws may be sponsored, such as GG Cola monthly draw 1610e.

Draw eligibility requirement 1630 provides the eligibility requirements that a user must satisfy in order to participate in a draw. Elements 1630a-1630e provide some examples of eligibility requirements, such as user's online presence 1630a, number of friends the user has 1630b-1630d, and user expressing liking for the sponsor page 1630e. Various combinations of these requirements and others are also possible.

Draw time 1640 may contain the time when a draw is to be performed. Draw times 1640a-1640e provide some examples of draw times.

Draw sponsor 1650 identifies the sponsor of the draws, if any. Draw sponsor field 1650 is analogous to game sponsor field 340 of FIG. 3 and tournament sponsor field 470 of FIG. 4. In some cases, a draw may be sponsored by more than one sponsors concurrently. In some other cases, a draw may be partially sponsored by an advertiser, and partially by the gaming system.

Draw prize 1660 indicates the reward associated with user participation in a draw. Draw prizes 1660a-1660e illustrate some examples of prizes.

In some cases, draw prize 1660 includes information regarding the criteria for determining whether a user has won a prize, for example whether only one user will win a prize or whether multiple users may be winners. Draw prize 1660 may also include information about adjusting the prize to be awarded for participation in a draw according to other criteria, such as the number of participants in the draw.

Reference is made to FIG. 17, which illustrates a process flow 1700 for a method of providing a social gaming activity in accordance with an example embodiment. The process 1700 is carried out by the various modules of a gaming system, such as the draw module 200 of the gaming system 200.

At 1702, user eligibility for participating in a draw is determined. In various cases, user eligibility is determined by comparing draw eligibility requirement, such as draw eligible requirement 1630 in a draw database 1600, with corresponding information from the user profile stored in the gaming system, such as in memory module 220 of the gaming system 200. For example, if the eligibility requirement for a daily draw is online presence of the user, the gaming system determines whether the user is eligible to participate in the draw by determining whether the user is online based on the user profile.

Eligibility for a draw may be determined with regard to any variety of criteria or combination of criteria including, but not limited to: online status, a threshold number of friends, a threshold number of referred friends, liking a sponsor page, sharing a sponsor page, and the like.

At 1704, eligible users are entered into a draw. In some cases, the gaming system automatically determines user eligibility for various draws prior to draw time, and enters the user in those draws. In some other cases, the users may select certain draws in which the user wishes to enter. Some draws may have a draw cut-off time, after which no more users can be entered into those draws. Once the eligible users enter the draw, the gaming system may update the user profile and the draw database to reflect this information.

At 1706, the draw is performed. A draw may be performed by randomly selecting one participant from all the participants of the draw.

At 1708, the gaming system determines the winner of the draw. In some cases, there may be more than one winners of each draw. The gaming system determines the number of possible winners per draw from a draw database, such as draw database 1600.

At 1710, a reward is provided to the winner or winners of the draw. In some cases the reward is in the form of virtual currency. In some other cases, the reward may be a tangible reward, such as real currency, products, good and services offered by sponsors, and/or discount coupons for such goods and services. The gaming system may update draw database and user profile to reflect this information.

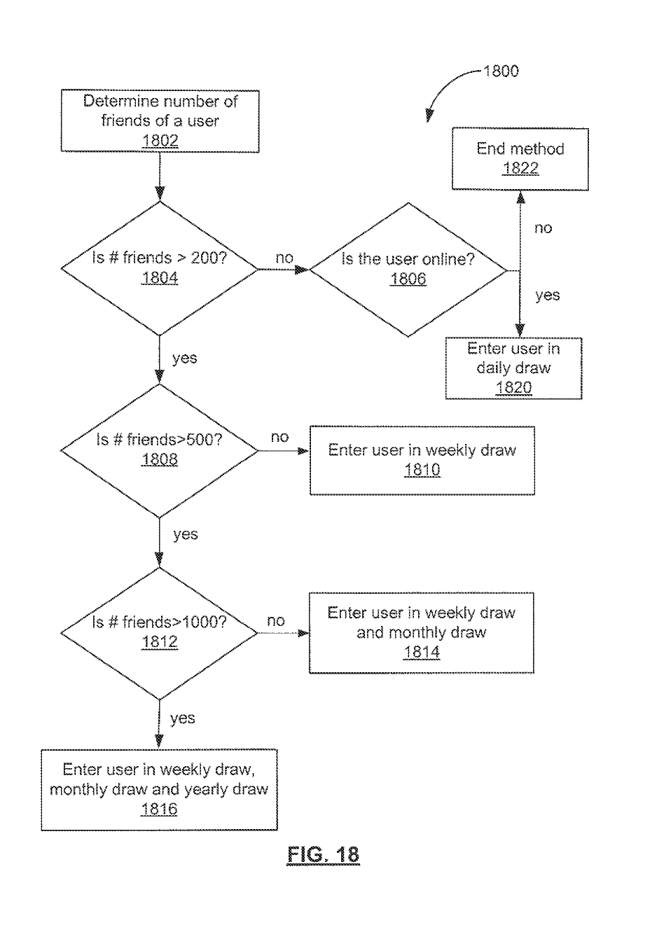

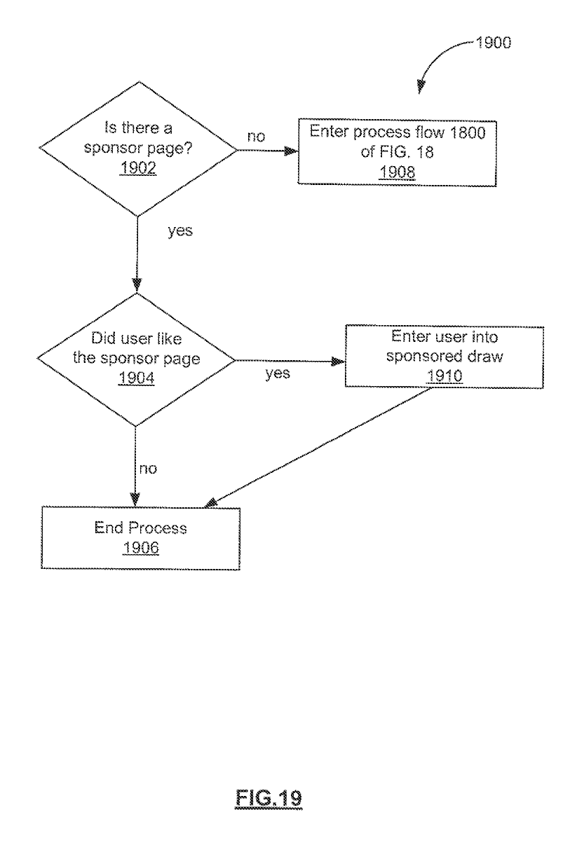

Reference is made to FIG. 18, which illustrates a process flow 1800 for a method of providing a social gaming activity in accordance with an example embodiment. The process 1800 is carried out by the various modules of a gaming system, such as the draw module 230 of the gaming system 200. The social gaming activity provided in this process flow 1800 is a draw.

At 1802, the gaming system determines the number of friends of a user. The gaming system may determine this from the user profile stored within the memory of gaming system.

At 1804, the gaming system determines whether the user has more than 200 friends. The gaming system determines the eligibility requirement for draws from a draw database, such as draw database 1600. If the gaming system determines that the user does not have 200 friends, the gaming system determines if the user is at least online at 1806. If the user is online, then the user is entered into a daily draw at 1820. If the user is not online, then the user is not entered into any draw and the process flow terminates at 1822.

If the gaming system determines that the user has 200 friends, it next determines if the user has more than 500 friends at 1808. If the user does not have more than 500 friends, then the user is entered into a weekly draw. In some cases, the user is entered into both the daily and the weekly draws. In some further cases, it is determined if the user is online, and if so, the user is entered into both the daily and weekly draws.

If the gaming system determines that the user has more than 500 friends, it then determines if the user has more than 1000 friends at 1812. If the gaming system determines that the user does not have more than 1000 friends, the user is entered into a weekly and a monthly draw at 1814. In some other cases, the user may also be entered into a daily draw if the user is found to be online.

If the gaming system determines that the user has more than 1000 friends, then the user is entered into weekly, monthly and yearly draws at 1816. In some other cases, the user is also entered into daily draws if the user is found to be present online.

Reference is made to FIG. 19, which illustrates a process flow 1900 for a method of providing a social gaming activity in accordance with an example embodiment. The process 1900 is carried out by the various modules of a gaming system, such as the draw module 230 of the gaming system 200. The social gaming activity provided in this process flow 1900 is a draw.

At 1902, gaming system determines whether the draw is offered on a sponsor page. The gaming system may determine this based on a draw database, such as draw database 1600 of FIG. 16.

If the draw does not have an associated sponsor page, the gaming system directs the process flow to act 1802 of process flow 1800 of FIG. 18 at 1908. If the draw is offered on the sponsor page, the gaming system determines whether the user has liked the sponsor page at 1904. This may be determined based on information stored in the user profile associated with the user.

If the gaming system determines that the user has liked the sponsor page, then the user is entered into the draw at 1910. If the gaming system determines that the user did not like the sponsor page, then the process flow terminates at 1906.

In some other cases, if the gaming system determines that the draw has a corresponding sponsor page, the user may be required to have a predetermined number of friends as well as like the sponsor page to be eligible to enter the draw. In the embodiment illustrated in FIG. 19, the predetermined number of friends is 0. In some other embodiments, the predetermined number of friends may be any number, such as 100, between 200 and 299, 500, 1000 etc.

In various cases, the rewards of the draw may vary based on a predetermined number of friends associated with the user. This can be gauged from a user profile associated with the user. For example, in some cases, a reward is 50 units of virtual currency if the user has a friend count of less than 50. In some other cases, a reward is $100 real currency if the user has a friend count between 200 and 299.

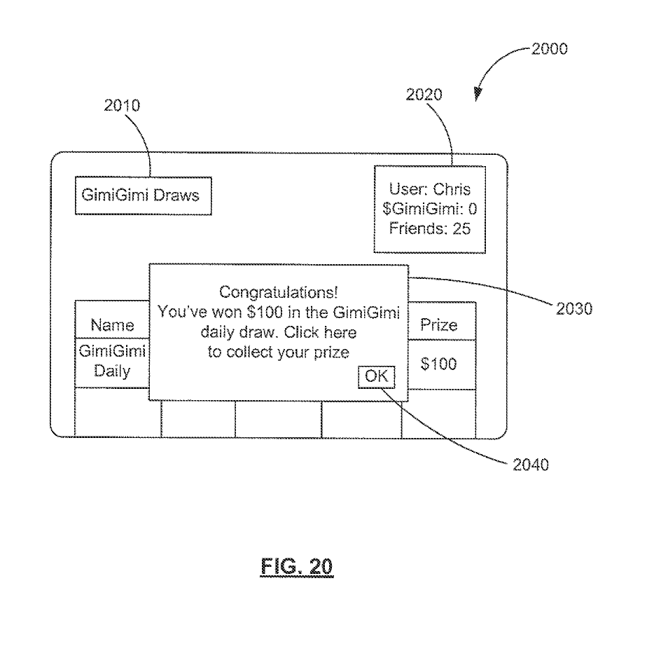

Reference is next made to FIG. 20, illustrating a display interface 2000 of a gaming system according to one embodiment. The display interface 2000 is configured by the gaming system for display to the users of the gaming system. The display interface 2000 illustrates a screen shot that is provided to a user when the user notifying the user that he/she has won a daily draw.

Display interface 2000 includes an information box 2020 which identifies the user who participated in the daily draw. The information box 2020 includes information, such as user name, virtual currency in user account, and a number of friends the user has, as illustrated. The information box may display other related information.

In some cases, the user is eligible to win only if the user is present online. In such cases, the user's online status is also displayed in the information box 2020.

Display interface identifies the type of social gaming activity the interface relates to. As illustrated, the display interface includes a title box 2010 for identifying that the interface 2000 relates to GimiGimi Draws. In cases where the sponsored draws are in question, the display interface will indicate the name of the sponsored draw in box 2010.

Display interface 2000 also includes a message box 2030 which notifies to the user that the user has won a draw. Message box 2030 also indicates the reward won. In some other cases, more information, such as number of participants, may also be included in the message box 2030.

Display interface 2000 also includes an interactive button such as button 2040 for allowing the user to acknowledge the receipt of the message box 2030.

Reference is made to FIG. 21, which illustrates an advertisement database 2100 according to an example embodiment. Advertisement database 2100 is stored in a gaming system, such as memory module of gaming system 200. Advertisement database 2100 may be stored in a relational (such as a Structured Query Language (SQL) database), or other suitable data storage database.

An advertisement database 2100 contains information about the advertisements stored in the gaming system. Such information includes ad title 2110 identifying the title of the advertisement; ad type 2120 identifying the type of the advertisement; ad sponsor 2130 identifying the sponsor of the advertisement; ad play count 2140 identifying statistics related to the frequency of views and user interaction; ad display rule 2150 identifying rules regarding when the advertisement is to be displayed; and cost 2160 identifying the amount charged by the gaming system from the sponsors of the advertisements for showcasing the advertisements to the users of the gaming system. In some other cases, additional information may be stored in the advertisement database 2100.

The gaming system is configured to update the advertisement database 2100 based on the communication from the sponsors and advertisers. The gaming system updates the advertisement database 2100 to add more advertisement fields, to modify existing fields, and to delete fields all together.

In some embodiments, the advertisement database 2100 includes links to sponsor pages that are maintained by sponsors and/or advertisers. In such embodiments, the gaming system connects the user to the sponsor page and monitors and records user interaction with the advertisements offered on the sponsor page. The gaming system uses this information to update the entries of the advertisement database 2100, such as, for example, the ad play count field 2140. The gaming system can accordingly adjust the cost entry 2160 based on this information.

Ad title 2110 represents the name or title of the advertisement as it would be presented to a user. Ad titles 2110a-2110c provide some examples of ad titles. Ad title 2110 may be accessed by various modules of a gaming system, such as the advertiser module 260, in order to provide the user with the titles of ads contained within the system.

Ad type 2120 identifies the type of the advertisement. As mentioned before, an advertisement can be interactive 2120b and 2120c or non-interactive 2120a. An interactive advertisement permits the viewers to interact with the advertisement. In some cases, the gaming system monitors the level of user interaction. In some other cases, the sponsor system monitors the level of user interaction, which is then provided to the gaming system. In many cases, the gaming system uses these statistics to negotiate a charge from the advertisers or sponsors for displaying their advertisements to the users.

Ad sponsor entry 2130 identifies the sponsors associated with each advertisement in the advertisement database 2100. For example, as illustrated, one advertisement is sponsored by XY Theatre 2130a, another by JKL Tutoring Software 2130b and another by GG Cola 2130c.

Ad play count 2140 records information related to how many times the advertisement is viewed and the level of user interaction with the advertisement in the case of an interactive advertisement. In some cases, the ad play count 2140 entry only records the number of times the advertisement is viewed, irrespective of whether the advertisement is interactive or non-interactive.

In some other cases, the ad play count 2140 entry records the number of times the advertisement is viewed for a non-interactive advertisement. For an interactive advertisement, the ad play count 2140 records the level of user engagement with the advertisement. This is illustrated in FIG. 21, where entry 2140a represents the total number of views for the non-interactive advertisement 2110a, and entries 2140b and 2140c represent the level of user engagement for advertisements 2110b and 2110c, respectively.

In some further cases, the ad play count 2140 records the number of views for the non-interactive advertisements, and both the number of views and the level of user engagement for the interactive advertisements.

Ad display rule 2150 identifies the rules or conditions controlling when the advertisement is played. Ad display rules 2150a-2410c provide some examples of ad display rules. For example, some advertisements may be displayed randomly. In such cases, the gaming system may determine whether or not to display such an advertisement to a user based on the previous advertisements viewed by the user. The gaming system may further determine whether or not to display a particular advertisement to the user based on user's previous interaction with the same or related advertisement.

In some other cases, the display rules 2150 specify when the advertisement should be viewed, such as, for example, during a particular kind of game, e.g. during Kid's games 2150b, or based on geographic locations of the user, e.g. for U.S. users 2150c, etc.

As previously mentioned, ad cost 2160 indicates the amount charged by the gaming system from sponsors and advertisers for playing their advertisements for users of the social gaming platform. Ad costs 2160a-2160c provide some examples of ad cost. Ad costs may be recorded based on charge per view, such as entry 2160a, or charge per play, such as entries 2160b and 2160c, or a combination of both. A ‘charge per play’ entry specifies the amount charged from the sponsors based on per instance of user interaction, such as per click, or per question answered etc. A ‘charge per view’ entry specifies the amount charged from the sponsors based on per view of the advertisement.

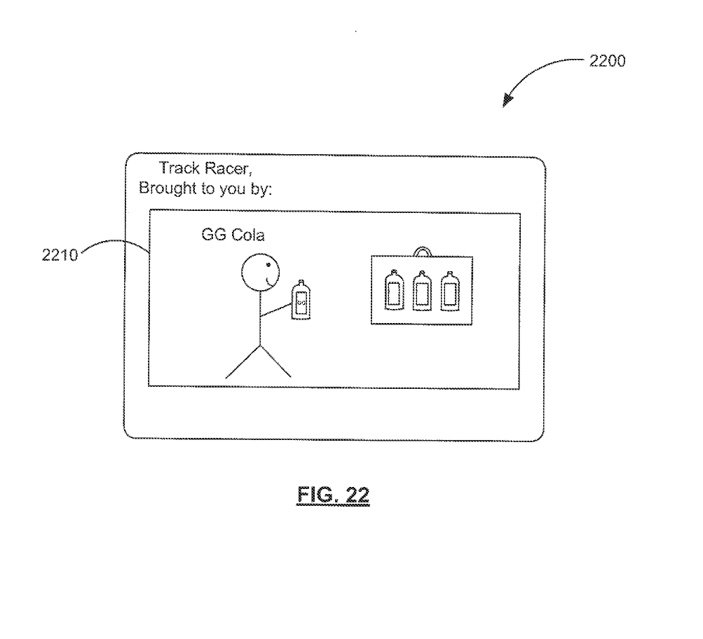

Reference is made to FIG. 22, which illustrates a display interface 2200 of a gaming system according to one embodiment. The display interface 2200 is configured by the gaming system for display to the users of the gaming system. The display interface 2200 illustrates a screen shot of a non-interactive portion of an interactive advertisement presented to a user of the social gaming platform.

As previously mentioned, an interactive advertisement may have interactive and non-interactive portions. Display interface 2200 includes a pop-up window 2210 displaying a non-interactive portion of an interactive advertisement. The advertisement may be provided before, during, or after the social gaming activities. As illustrated, window 2210 identifies the sponsor for the advertisement.

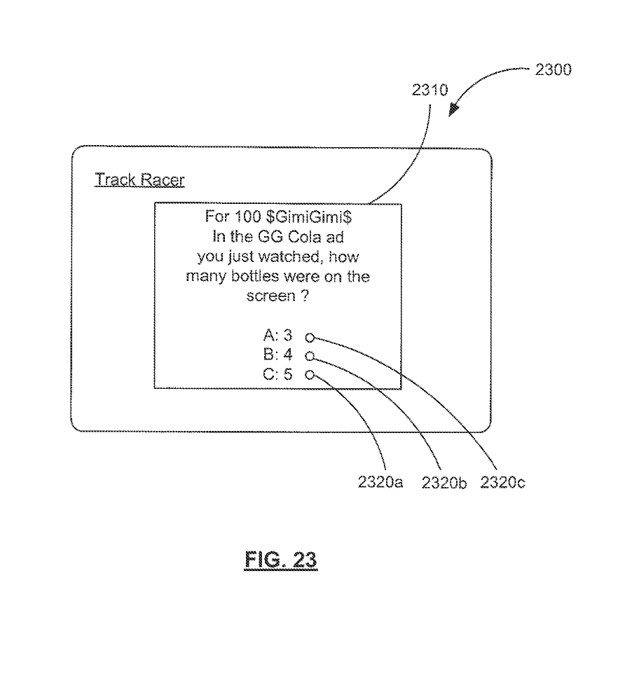

Reference is made to FIG. 23, which illustrates a display interface 2300 of a gaming system according to one embodiment. The display interface 2300 is configured by the gaming system for display to the users of the gaming system. The display interface 2300 illustrates a screen shot of an interactive portion of the interactive advertisement of FIG. 22.

Display interface 2300 includes a quiz at the end of the non-interactive portion of the interactive advertisement, where the question in the quiz is based on the content displayed in the non-interactive portion. This provides an opportunity to the gaming system to gauge user attentiveness with the advertisement.

A quiz box 2310 within the display interface 2300 includes a question along with three selectable choices 2320a, 2320b and 2320c. The selectable choices may be selected by clicking on an interactive box adjacent to the choice, as illustrated. Other ways of making a selection may be provided.

In various cases, the gaming system receives the user selection and determines whether the user has provided a correct answer based on the selection. If the user answers the question correctly, the gaming system may reward the user by providing, for example, some virtual currency, or a discount coupon associated with the sponsor, etc. In some cases if the user doesn't answer the question correctly, additional advertisement may be displayed to the user before the user can resume the social gaming activity.

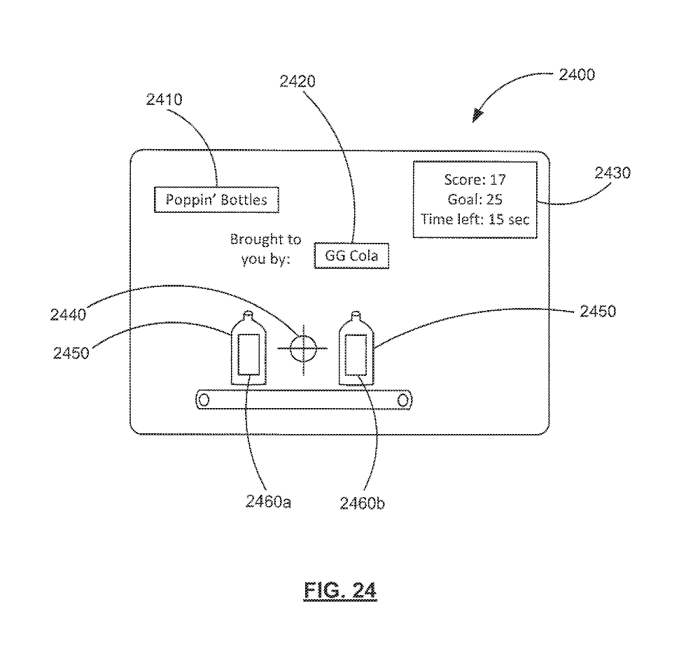

Reference is made to FIG. 24, which illustrates a display interface 2400 of a gaming system according to one embodiment. The display interface 2400 is configured by the gaming system for display to the users of the gaming system. The display interface 2400 illustrates a screen shot of an interactive advertisement. As illustrated, the interactive advertisement in this case is a target shooting game.

Display interface 2400 includes the title of the advertisement 2410, the name of the sponsor 2420 and an information box 2430 displaying the progress made in the game within the interactive advertisement. For example, the information box 2430 includes the current score, the goal and the remaining time associated with the game.

The target shooting game in this embodiment is designed to allow a user to locate and shoot the product or products, such as bottles 2450, showcased in the advertisement every time the product or products are displayed.

Display interface 2400 includes a cursor 2440 that is controlled by the user in order to attempt to hit the targets 2460a and 2460b situated on the products 2450.

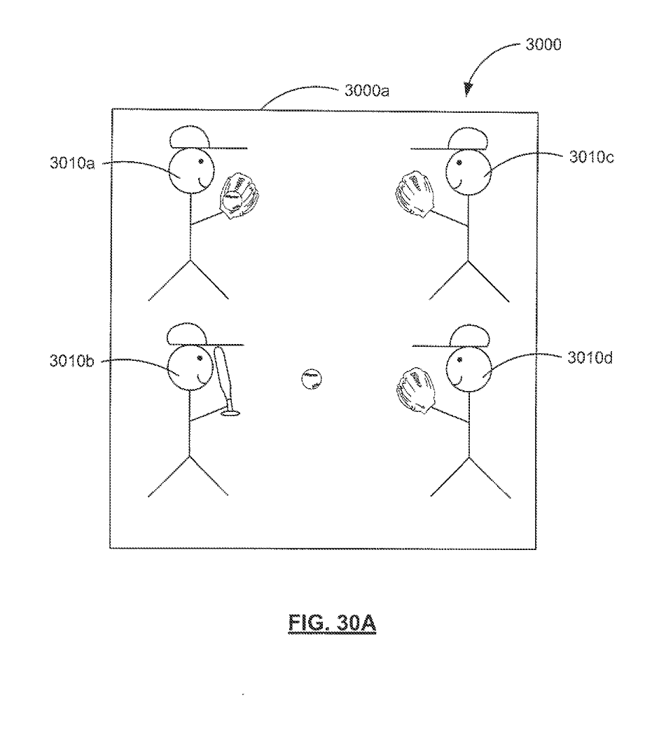

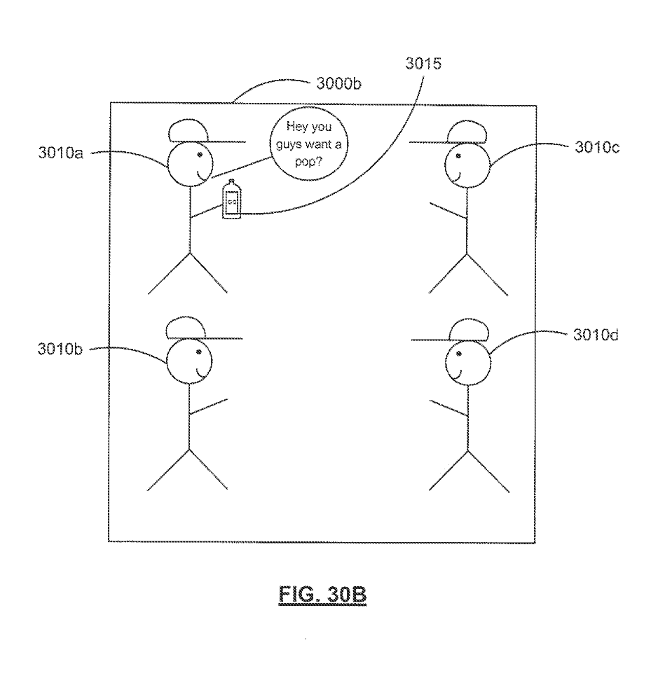

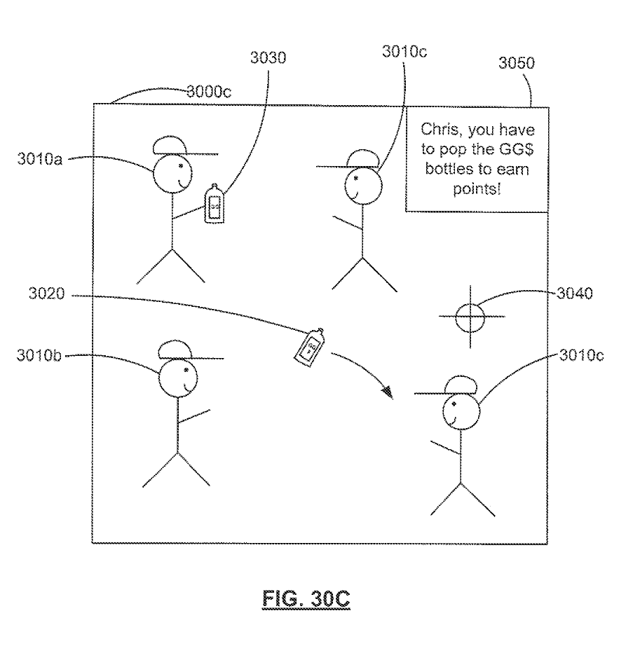

Reference is made to FIGS. 30A-C, which illustrate a display interface 3000 of a gaming system according to another embodiment. The display interface 3000 is configured by the gaming system for display to the users of the gaming system. The display interface 3000 illustrates screen shots 3000a-3000c of an interactive advertisement integrating gameplay within an advertisement storyline.

Screen shot 3000a illustrates a non-interactive portion of the advertisement where four players 3010a, 3010b, 3010c and 3010d are engaging in a baseball game.

Screen shot 3000b illustrates another non-interactive portion of the advertisement where one of the four players, player 3010a, shows the product 3015 of the sponsor of the advertisement. The product of the sponsor is integrated into the advertisement storyline as the four players are shown taking a break after the baseball game and player 3010a is shown with a pop can 3015 as refreshment.

Screen shot 3000c illustrates an interactive portion of the advertisement, where the interactive portion is configured for the user. By using user's name in the advertisement, the advertisement is made more personalized and interesting for the viewer.

Screen shot 3000c illustrates a game where the viewer is expected to pop or click on the bottles that are marked ‘GG$’, such as bottle 3020. The bottles are GG cola product bottles, where some bottles are marked ‘GG’, such as bottle 3030, and some others are marked ‘GG$’, such as bottle 3020. The viewer's goal in this interactive game is to pop as many sponsor bottles marked ‘GG$’ as possible, while they are in the air, to accumulate points.

Interactive advertisements, such as those disclosed in the embodiments described in FIGS. 24 and 30A-C, provide an efficient way to allow the viewer to pay attention to the products of the advertisers or sponsors. Integrating gameplay into advertisement and associating a reward with the performance in the gameplay discourages the user from skipping or ignoring the advertisement.

In some embodiments, the gaming system makes it compulsory for the user to provide at least one input to the game within the interactive advertisement. Failing to do so may prevent the user from participating in the social gaming activity before, after or during which the interactive advertisement is being displayed.

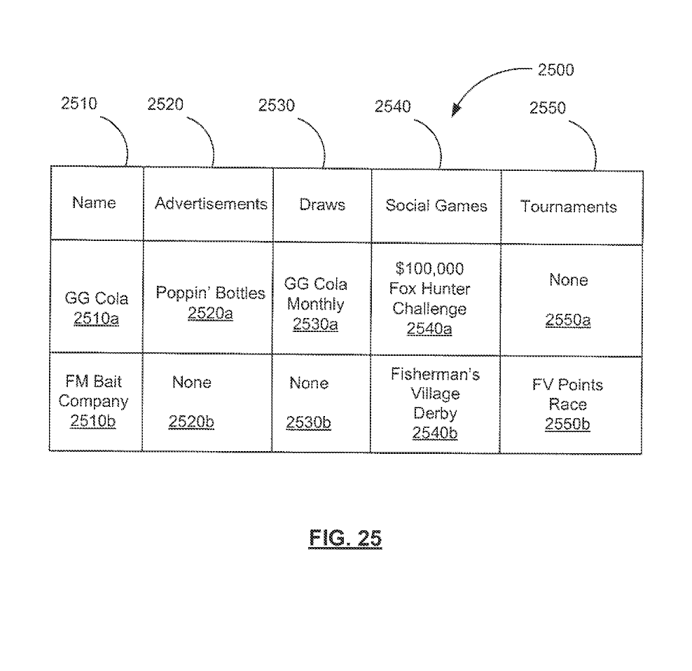

Reference is made to FIG. 25, which illustrates a sponsor database 2500 according to an example embodiment. Sponsor database 2500 is stored in a gaming system, such as memory module 220 of gaming system 200. Advertisement database 2500 may be stored in a relational database (such as a Structured Query Language (SQL) database), or other suitable data storage database.

A sponsor database 2500 provides consolidated information about the sponsors and advertisers communicating with the gaming system. In some cases, the gaming system allows sponsors and businesses to sign up and create an account with the gaming system. The sponsors can create an account by providing identification information, including, but not limited to, business name, products, location, types of activities the businesses want to sponsor, types of awards the business want to offer, and the like.

The gaming system maintains a sponsor database, such as the sponsor database 2500. The sponsor database 2500 according to this embodiment identifies the sponsor name 2510; any sponsored advertisements, interactive or non-interactive, 2520; any sponsored draws 2530, any sponsored social games 2540, and any sponsored tournaments 2550.

As illustrated, a business GG Cola 2510a is sponsoring an advertisement ‘Poppin’ Bottles' 2520a, a monthly draw ‘GG Cola Monthly’ 2530a and a social game offering a reward worth $100,000 in real money, ‘$100,000 Fox Hunter Challenge’ 2540a. Another entry in the sponsor database 2500 corresponds to a sponsor ‘FM Bait Company’ 2510b, who is sponsoring a social game ‘Fisherman's Village Derby’ 2540b and a tournament titled ‘FV Point Race’ 2550b.

Sponsor database 2500 is communicably linked to other databases stored in the memory module of the gaming system. These databases include, but are not limited to, a game database, such as game database 300 of FIG. 3, a tournament database, such as tournament database 400, a draw database, such as draw database 1600 and an advertisement database, such as advertisement database 2100. Each entry in the sponsor database 2500 is linked to corresponding entries in one or more of the game, tournament, draw and advertisement databases.

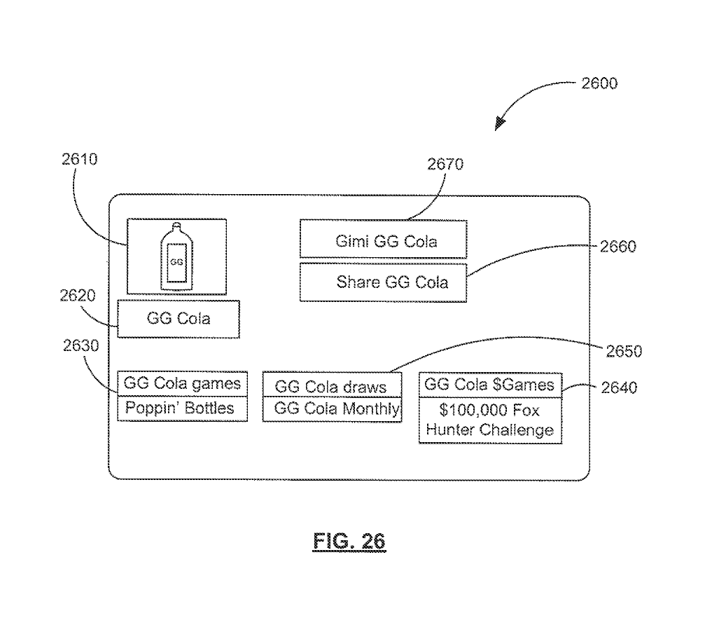

Reference is made to FIG. 26, which illustrates a display interface 2600 of a sponsor page according to an embodiment. The display interface 2600 may be configured by a gaming system, such as gaming systems 100 and 200, for display to the users of the gaming system.

Display interface 2600 includes an advertiser logo 2610, advertiser name 2620 as well as activities associated with and sponsored by the advertiser, such as interactive advertisements 2630, draws 2650 and social games 2640. In most cases, the display interface contains elements, such as skins, banner advertisements, text, audio/video content etc., displaying and promoting the sponsor.

Display interface 2600 also includes a share button 2660 which the user can use to share the sponsor page with other users, and with his/her friends on the social gaming platform and not on the social gaming platform. In some cases, the user uses this feature to refer his/her friends to the social gaming platform.

Display interface 2600 also includes a Gimi button 2670, which a user can use to express his/her liking for the sponsor page, sponsor products and/or brand name.

In some cases, selecting the share button 2660 or the Gimi button 2670 by, for example, clicking on it, allows the user to earn points, such as in the form of virtual currency. In some other cases, sharing and/or liking the sponsor page is a pre-requisite to participating in activities provided on the sponsor page.

When a user interacts with a Gimi button, such as Gimi button 2670 or a share button, such as share button 2660, this may be reflected in the social gaming platform for other users to see. User interactions with the Gimi button 2670 or the share button 2660 may also be reflected in a public event log such as a newsfeed.

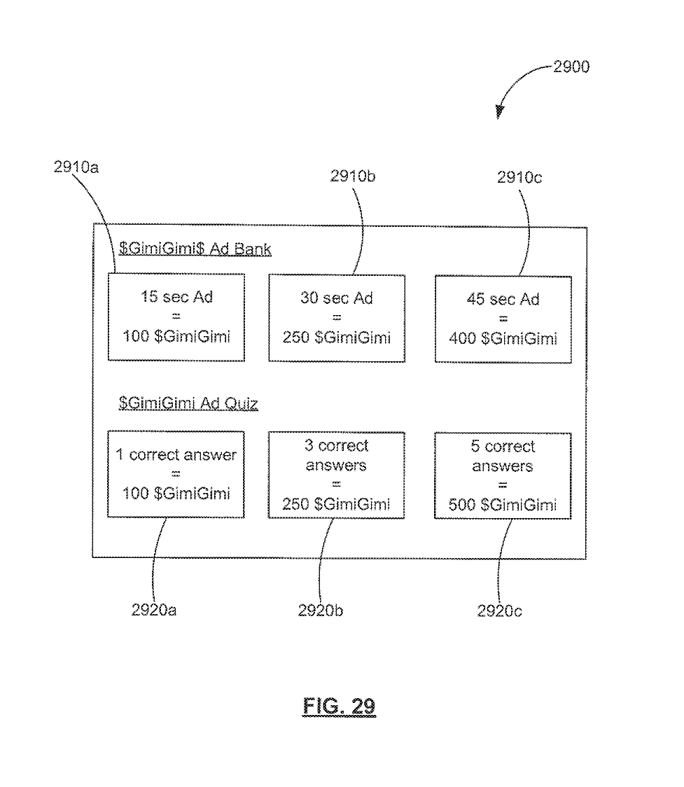

Reference is next made to FIG. 29, illustrating a display interface 2900 of a gaming system according to an embodiment. The display interface 2900 may be configured by a gaming system, such as gaming systems 100 and 200, for display to the users of the gaming system.

Display interface 2900 illustrates a screen shot of an advertisement selection page. The user can visit the advertisement selection page to view enlisted advertisements in exchange for virtual currency. In cases, where the user does not meet the eligibility requirement for certain social gaming activity because of insufficient virtual currency, the user can visit the advertisement selection page and select advertisements to view and/or participate in to earn virtual currency.

The advertisement selection page may include both interactive and non-interactive advertisements. As illustrated, the advertisement selection page includes non-interactive advertisements 2910a-2910c, where the virtual currency that can be earned by the user is based on the length of the advertisements.

The advertisement selection page also includes interactive advertisements 2920a-2920c, where the virtual currency that can be earned by the user is based on the level of user engagement with the advertisements. As illustrated, the virtual currency that can be earned by the user in this embodiment is based on the number of correct answers given by the user in a quiz, such as the quiz in FIG. 23.

Reference is now made to FIG. 27, which illustrates a user database 2700 according to an example embodiment. User database 2700 is stored in a gaming system, such as memory module 220 of gaming system 200. User database 2700 may be stored in a relational database (such as a Structured Query Language (SQL) database), or other suitable data storage database.

A user database contains information about the account holding users of the social gaming system. The user database 2700 contains fields including, but not limited to, a user name field 2710, a user friend count field 2720, a virtual currency field 2730, a friend referral count field 2740, an online status field 2750, and a rewards field 2760. In some other cases, user database 2700 contains additional fields, including, but not limited to, number of advertisements watched, last watched advertisement, time and date of last participation in social gaming activity, last added friend, time and date for every social game activity participation, time and date for added friends, time and date for friends referred, and the like.

User name field 2710 identifies the name of the user. The name of the user is received form the user when the user is creating an account with the social gaming platform. This may be user's real name or user's screen name. Names 2710a-2710c are some examples of user names in this embodiment.

Friend count field 2720 contains information regarding the number of friends of the user. In some cases, the friend count field 2720 also identifies the names and/or identities of the friends. Entries 2720a-2720c are some examples of friend counts in this embodiment.

The friend count field 2720 may be accessed by various modules of the gaming system, such as game module (e.g. game module 250 of FIG. 2), draw module (e.g. draw module 230 of FIG. 2) and advertisement module (e.g. advertisement module 260 of FIG. 2). In some cases, the friend count field 2720 is used by the various modules of the gaming system to determine user eligibility in various social gaming activities. In some other cases, the friend count field 2720 is accessed by the various modules of the gaming system to determine user rewards.

Virtual currency field 2730 contains information regarding the amount of virtual currency a user has accumulated. In various cases, the virtual currency field 2730 is used by various modules of the gaming system to determine user eligibility in various social gaming activities. Entries 2730a-2730c are some examples of virtual currency in this embodiment.

Friend referral count field 2740 contains information regarding the number of friends referred to the gaming system by the user. Entries 2740a-2740c are some examples of friend referral count. In some cases, the user eligibility to participate in social gaming activities is based on the friend referral count.

Online status entries, such as entries 2750a-2750c, indicate whether the user is currently online or offline in the gaming system. In some cases, this information is accessed and used by various modules of the gaming system to determine user eligibility in various social gaming activities.

Rewards 2760 contain information regarding all the rewards the user has won in various social gaming activities. In some cases, rewards field 2760 includes user rankings in various social gaming activities, as illustrated by entry 2760b. In some other cases, rewards field 2760 includes prizes won by the user owing to the participation in certain social gaming activities, as illustrated by entry 2760c.

Reference is made to FIG. 28, which illustrates a display interface 2800 of a gaming system according to an embodiment. The display interface 2800 is configured by the gaming system for display to the users of the gaming system. The display interface 2800 illustrates a screen shot of a user profile page as it appears on the social gaming platform.

User profile page 2800 includes a user picture field 2810 for displaying an image selected by the user, user identification information field 2820 for providing information related to user identity, user name field 2830 for identifying the name of the user, social gaming activities field 2840 for providing a list of social gaming activities that the user is currently participating in, user friend count field 2850 for providing the number of friends of the user on the social gaming platform and an invite friend button 2860 for permitting the user to add existing users to the user profile or refer non-account holders to the social gaming platform. Additional information may be displayed on the user profile page.

As illustrated, user identification information 2820 displays user's age, sex, hometown, occupation and virtual currency count corresponding to the user. User identification information 2820 may include addition information, such as, for example, user's interests, user's online status, user's education etc.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. The scope of the claims should not be limited by the preferred embodiments and examples, but should be given the broadest interpretation consistent with the description as a whole.

1. A method of operating a gaming system, the gaming system being configured to interface with a client system, the method comprises:
operating at least one processor to establish a database of activity records, the database having at least one activity record associated with a social gaming activity, each activity record having an eligibility field identifying an eligibility requirement associated with the social gaming activity;
storing the database in a memory;
receiving, from the client system, a membership request, the membership request configuring the at least one processor to generate a client profile corresponding to the client system in the memory;
providing, to the client system, data identifying the activity records;
receiving, from the client system, a selection request identifying a first selected social gaming activity;
determining if the client system is eligible to participate in the first selected social gaming activity based on the eligibility field of the activity record corresponding to the first selected social gaming activity; and
enrolling the client system in the social gaming activity when eligibility is established.

2. The method of claim 1, further comprising receiving a referral request from the client system, the referral request configuring the at least one processor to provide a connection to the gaming system to a non-client system identified in the referral request.

3. The method of claim 1, further comprising:
receiving a friend request from the client system, the friend request identifying another client system having a corresponding client profile generated in the memory; and
configuring the at least one processor to connect the client system to the client system identified in the friend request.

4. The method of claim 1, further comprising operating the at least one processor to establish a database of user records, each user record corresponding to one client profile from a plurality of client profiles generated in the memory.

5. The method of claim 4, wherein each user record comprises a friend count field, the friend count field identifying a total number of friends associated with the user record.

6. The method of claim 5, wherein the friend count field is incremented when the at least one processor is configured to connect one client system to another client system in response to a friend request.

7. The method of claim 1, further comprising operating the at least one processor to establish a database of advertisement records, each advertisement record corresponding to an advertisement.

8. The method of claim 7, where the advertisement is a non-interactive advertisement.

9. The method of claim 7, wherein the advertisement is an interactive advertisement.

10. The method of claim 9, further comprising recording an engagement level of a client system towards the interactive advertisement.

11. The method of claim 10, further comprising providing virtual currency to the client system based on the recorded engagement level.

12. The method of claim 7, further comprising recording the number of advertisements viewed by the client system.

13. The method of claim 12, further comprising providing a credit to the client system based on the number of advertisements viewed.

14. The method of claim 13, wherein the credit comprises virtual currency.

15. The method of claim 13, wherein the credit comprises real currency.

16. The method of claim 1, wherein operating the at least one processor to establish a database of activity records comprises operating the at least one processor to establish a database of game records, each game record corresponding to a social game.

17. The method of claim 1, wherein operating the at least one processor to establish a database of activity records comprises operating the at least one processor to establish a database of tournament records, each tournament record corresponding to a tournament.

18. The method of claim 1, wherein operating the at least one processor to establish a database of activity records comprises operating the at least one processor to establish a database of draw records, each draw record corresponding to a draw.

19. A gaming system for providing a social gaming activity to a client system, the gaming system being configured to interface with the client system, the system comprising at least one processor configured to:
establish a database of activity records, the database having at least one activity record associated with a social gaming activity, each activity record having an eligibility field identifying an eligibility requirement associated with the social gaming activity;
store the database in a memory;
receive, from the client system, a membership request, the membership request configuring the at least one processor to generate a client profile corresponding to the client system in the memory;
provide, to the client system, data identifying the activity records;
receive, from the client system, a selection request identifying a first selected social gaming activity;
determine if the client system is eligible to participate in the first selected social gaming activity based on the eligibility field of the activity record corresponding to the first selected social gaming activity; and
enroll the client system in the social gaming activity when eligibility is established.

20. A computer-readable medium storing computer-executable instructions, the instructions for causing at least one processor to perform a method of operating a gaming system, the gaming system being configured to interface with a client system, the method comprising:
operating at least one processor to establish a database of activity records, the database having at least one activity record associated with a social gaming activity, each activity record having an eligibility field identifying an eligibility requirement associated with the social gaming activity;
storing the database in a memory;
receiving, from the client system, a membership request, the membership request configuring the at least one processor to generate a client profile corresponding to the client system in the memory;
providing, to the client system, data identifying the activity records;
receiving, from the client system, a selection request identifying a first selected social gaming activity;
determining if the client system is eligible to participate in the first selected social gaming activity based on the eligibility field of the activity record corresponding to the first selected social gaming activity; and
enrolling the client system in the social gaming activity when eligibility is established.
